(19) United States
(12) Patent Application Publication
(10) Pub. No.: US 2026/0330824 A1
(43) Pub. Date: Oct. 22, 2026

(54) Cloud-Informed Image Capture

(71) Applicant: Planet Labs PBC, San Francisco, CA (US)

(72) Inventors: Kiruthika Devaraj, Sunnyvale, CA (US); Shreeyam Kacker, San Francisco, CA (US)

(21) Appl. No.: 19/730,158

(22) Filed: Jul. 2, 2026

Related U.S. Application Data
(63) Continuation-in-part of application No. 18/345,883, filed on Jun. 30, 2023.

(51) Int. Cl. G06V 20/13; G06N 3/0464; H04N 23/661

(52) U.S. Cl. CPC G06V 20/13; G06N 3/0464; H04N 23/661

(57) ABSTRACT

Systems and methods for cloud avoidance and autonomous satellite tasking are presented. A computing system obtains forward-looking sensor data associated with a field of view that corresponds to a future field of view of an imagery sensor. A model, such as a convolutional neural network, analyzes the sensor data to determine estimated cloud coverage for one or more geographic regions. This analysis may include segmenting image frames into a plurality of blurred image segments to identify cloud characteristics and determine coverage percentages. The system compares the determined cloud coverage to a threshold level and generates a success or failure metric. Based on this comparison, the satellite may select an image target where coverage is below the threshold or transmit metrics to a ground-based station to inform tasking decisions. Command instructions are generated to modify satellite orientation and control imagery collection based on the satellite’s current location and availability.

### PRIORITY CLAIM

This application is a continuation-in-part of and claims the benefit of priority to U.S. Patent Application No. 18/345,883, filed on Jun 30, 2023. The present application claims priority to, benefit of, and incorporates by reference the entirety of the contents of the cited application.

### FIELD

The present disclosure relates generally to techniques to avoid clouds on slew trajectories of satellites. More particularly, the present disclosure relates to systems and methods for avoiding cloud cover using a forward-looking sensor and a model to determine target geographic regions along a trajectory of a satellite.

### BACKGROUND

A constellation of imaging satellites can be utilized to acquire imagery. The satellites can be controlled to acquire the imagery by, for example, a ground-based control center. The control center can uplink commands to the satellites and receive imagery via a satellite downlink.

### SUMMARY

Aspects and advantages of embodiments of the present disclosure will be set forth in part in the following description, or can be learned from the description, or can be learned through practice of the embodiments.

One example embodiment of the present disclosure is directed to a computing system of a satellite. The computing system includes one or more sensors comprising a forward-looking sensor and an imaging sensor. The computing system includes one or more processors and one or more tangible, non-transitory, computer-readable media storing instructions executable by the one or more processors to cause the computing system to perform operations. The operations include receiving a command to capture image data of an imaging target. The operations include obtaining forward-looking sensor data from the forward-looking sensor of the satellite. The operations include determining, based on the forward-looking sensor data, a cloud coverage associated with the imaging target. The operations include comparing the cloud coverage associated with the imaging target to a threshold level of cloud coverage. The operations include transmitting, based on comparing the cloud coverage associated with the imaging target to a threshold level of cloud coverage, an indication of a success metric or an indication of a failure metric associated with the forward-looking sensor data.

Another example embodiment of the present disclosure is directed to a computer-implemented method. The method includes receiving a command to capture image data of an imaging target using a satellite. The method includes obtaining forward-looking sensor data from a forward-looking sensor of the satellite. The method includes determining, based on the forward-looking sensor data, a cloud coverage associated with the imaging target. The method includes comparing the cloud coverage associated with the imaging target to a threshold level of cloud coverage. The method includes transmitting, based on comparing the cloud coverage associated with the imaging target to a threshold level of cloud coverage, an indication of a success metric or an indication of a failure metric associated with the forward-looking sensor data.

Another example embodiment of the present disclosure is directed to a non-transitory, computer-readable media storing instructions executable by the one or more processors can cause the computing system to perform operations. The operations include receiving a command to capture image data of an imaging target using a satellite. The operations include obtaining forward-looking sensor data from a forward-looking sensor of the satellite. The operations include determining, based on the forward-looking sensor data, a cloud coverage associated with the imaging target. The operations include comparing the cloud coverage associated with the imaging target to a threshold level of cloud coverage. The operations include transmitting, based on comparing the cloud coverage associated with the imaging target to a threshold level of cloud coverage, an indication of a success metric or an indication of a failure metric associated with the image data.

Yet another example embodiment is directed to a computer-implemented method. The method includes obtaining forward-looking sensor data of an image target using a forward-looking sensor of a satellite. The method includes analyzing, using a model, an image frame of the forward-looking sensor data. The method includes generating, using the model, a plurality of image segments, wherein the plurality of image segments is associated with one or more clouds depicted in the image frame. The method includes generating, using the model, a plurality of blurred image segments, wherein the plurality of blurred image segments are indicative of cloud characteristics. The method includes determining, using the model, a cloud coverage associated with respective blurred image segments of the plurality of blurred image segments. The method includes transmitting, based on the cloud coverage associated with respective blurred image segments, an indication of a success metric or an indication of a failure metric associated with the forward-looking sensor data.

Another example embodiment is directed to a computer-implemented method. The method includes obtaining, using a forward-looking sensor of a satellite, forward-looking sensor data associated with a forward-looking field of view, wherein the forward-looking field of view comprises an area of the Earth’s surface corresponding with a future field of view of an imagery sensor of the satellite. The method includes determining, based on the forward-looking sensor data, an estimated cloud coverage associated with one or more regions of the area of the Earth’s surface. The method includes selecting an image target from a region of the one or more regions within the future field of view, based on the estimated cloud coverage of the region being below a threshold level of cloud coverage. The method includes capturing, using the imagery sensor, image data of the image target.

Another example embodiment is directed to a computer-implemented method. The method includes obtaining forward-looking sensor data having a forward-looking field of view using a forward-looking sensor of a satellite, wherein the forward-looking field of view comprises an area of Earth’s surface in a trajectory direction of the satellite which corresponds with a future field of view of an imagery sensor of the satellite. The method includes determining, based on the forward-looking sensor data, an estimated cloud coverage associated with one or more regions of the area of the Earth’s surface. The method includes transmitting the estimated cloud coverage associated with the one or more regions to a ground-based station. The method includes receiving, from a remote computing device, an image target for collection of image data. The method includes transmitting to a remote computing device the estimated cloud coverage associated with a region of the one or more regions, in response to receiving the image target for the collection of image data by an image sensor of the satellite.

Yet another example embodiment is directed to a computer-implemented method for tasking a collection of imagery data from a satellite. The method includes receiving from the satellite an estimated cloud coverage associated with one or more regions on Earth’s surface within a field of view of a forward-looking sensor. The method includes determining the estimated cloud coverage using one or more processors of the satellite. The method includes receiving, from a remote computing device, an image target associated with a location on the Earth’s surface. The method includes determining a current location of the satellite and an availability of the satellite. The method includes generating a command configured to cause the satellite to collect the imagery data, based on the current location of the satellite and the availability of the satellite.

Other aspects of the present disclosure are directed to various methods, systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example satellite system according to example embodiments of the present disclosure;

FIGS. 2A-2B depict an example satellite including sensors according to example aspects of the present disclosure;

FIG. 3 depicts a block diagram of an example data pipeline according to example aspects of the present disclosure;

FIG. 4 depicts example image processing according to example aspects of the present disclosure;

FIG. 5 depicts an example flow diagram of an example method for recomputing targets according to example aspects of the present disclosure;

FIG. 6A depicts an example maneuvering plan according to example aspects of the present disclosure;

FIG. 6B depicts a diagram of an example system for controlling imaging satellites;

FIG. 6C provides a diagram overview of the RT communication pathway and the uplink/downlink communication pathway;

FIGS. 7A-D depict flowchart diagrams of example methods according to example aspects of the present disclosure; and

FIG. 8 depicts example system components according to example aspects of the present disclosure.

### DETAILED DESCRIPTION

Example aspects of the present disclosure are directed to techniques for avoiding cloud coverage for images taken by a satellite. For example, a satellite operator (i.e., a company, government agency, etc.) may utilize imagery satellites to capture images of geographic regions on earth upon request. A requesting company or individual may request that satellite images be captured of a specific geographic region, for which a payload sensor may be positioned on board the satellite to capture the desired image of the specific geographic region. Among other factors contributing to the quality or useability of the captured image, the requirements of the image may include a threshold level of tolerance of cloud coverage, which may obstruct visibility of portions of the Earth’s surface. For instance, clouds may obscure or block the desired imagery, or portions thereof. The satellite operator may assign the request to one or more satellites orbiting earth, which may have a trajectory that passes over or near the geographic region associated with the request, such that the payload sensor may be positioned to capture the desired image. In some examples, the assigned satellites may have instruments used to calculate or determine that the geographic region associated with the request is covered with clouds and fails to satisfy the threshold indicated by the request. For instance, sensor data processed by the satellite may indicate the presence of cloud coverage. In some examples, cloud coverage above or below the defined threshold may result in images that do not satisfy the request. According to example aspects of the present disclosure, satellites may utilize a plurality of sensors, metadata, and models to avoid capturing cloud-obstructed images by generating imaging targets that include cloud coverage characteristics which satisfy the defined thresholds.

When a satellite operator receives a request, a ground-based command system may select a specific satellite based on its current location and availability. This selection process may be further informed by the satellite transmitting real-time estimated cloud coverage back to a ground station, allowing the system to provide feedback to a remote user device regarding the probability of a successful capture. Additionally, in instances where no tasks are scheduled, for example, the system may rank potential targets based on secondary priority metrics, such as the time elapsed since a prior image was captured, historical interest metrics, and/or the frequency of previous cloud-related imaging failures in that region.

For example, a cloud avoidance model running on-board a satellite may receive input sensor data, metadata, and/or trajectory data to determine one or more imaging targets where cloud cover is below or above a defined threshold (e.g., a tolerable level/percentage of cloud coverage in a given geographic area). Sensor data may include images or other data captured by one or more cameras or sensors on board the satellite.

Example sensors may include a VIS (visible imaging system) sensor, a LWIR (longwave infrared) sensor, or other types of sensors or cameras. In some examples, the satellite may include a forward-looking sensor. A forward-looking sensor may include one or more cameras which are positioned in a forward angle from nadir. Nadir is the point directly below the satellite relative to the Earth. For instance, the forward-looking sensor may be positioned +25 degrees relative to nadir. In some examples, the forward-looking sensor may allow the satellite to receive sensor data indicative of a potential path of travel for the satellite. The +25 degree angle may include a field of view ahead of the satellite such that the satellite may process sensor data within a time frame sufficient to adjust the trajectory of the satellite. For example, +25 degree angle may be calibrated such that sensor data obtained by the satellite is usable (e.g., not outdated). In some examples, a greater degree angle (e.g., + 50, +60, etc.) may allow for a time frame sufficient to adjust the trajectory of the satellite, but may also allow for conditions to change. For instance, clouds may form or change position between the time sensor data is captured and processed by the satellite and an updated trajectory reaches a potential imaging target. Additionally, or alternatively, a lesser angle (e.g., +15, +10, etc.) may provide more up-to-date prediction of the location and structure of clouds, but may not allow for suitable processing time for the satellite to process the sensor data from the forward-looking sensor and make any adjustments to the trajectory of the satellite. The angles relative to nadir used herein are illustrative in nature based on current satellite capability limitations, such as in processing speed, power consumption, and positioning systems. It is contemplated that as such satellite capabilities continue to improve, that an angle of less than +25 degrees may be desirable.

Satellites may also utilize metadata for cloud avoidance modeling. The metadata may include data such as the camera temperature, sun angle, Earth surface angle, or slew angle. For instance, the metadata may indicate additional information which may impact the accuracy of the sensor data or trajectory data. The trajectory data may include a current slew trajectory of the satellite. For instance, the current slew trajectory may include the satellite’s current orientation or movement in reference to its orbit track. In some examples, the current slew trajectory is associated with a path of travel that will pass over geographic regions (e.g., imaging targets) scheduled for image acquisition by the satellite.

The cloud avoidance model may process the sensor data and metadata to generate imaging targets which satisfy respective thresholds for cloud coverage. The satellite may generate an updated trajectory to avoid imaging targets which are covered by clouds. For instance, the cloud avoidance model may fuse the sensor data and metadata to allow for more accurate image data that compensates for environmental factors. Environmental factors may distort the sensor data and result in an inaccurate determination of cloud coverage. For example, sensor data may include a plurality of image frames. In some examples, the cloud avoidance model may perform segmentation to segment the image frames fused with the metadata based on clouds or other objects detected in the image frames. The cloud avoidance model may detect a plurality of clouds in an image frame and segment the image frame to encapsulate the respective clouds. In some examples, the cloud avoidance model may segment the image frames fused with metadata based on imaging targets. The cloud avoidance model may encapsulate the respective geographic region and further segment based on detected objects such as clouds. In some examples, the cloud avoidance model may project a blur box onto the segmented image frame. A blur box may be projected in 5 km increments, 10 km increments, etc., and blur the image segment. In some examples, blurring the image segment reduces the number of features that are needed to process the image frame by the cloud avoidance model. To improve accuracy, the forward-looking sensor may be configured to identify clouds by detecting specific spectral bands, such as those in the 1.36-1.38 μm range. By analyzing these spectral signatures, the onboard computing system can more reliably distinguish clouds from other high-albedo features like snow or ocean foam.

The cloud avoidance model may analyze the blurred image segment and determine, based on its features, the presence of clouds. In some examples, the cloud avoidance model may output one or more imaging targets (e.g., requested imagery of geographic regions) which do not contain cloud coverage or that satisfy a defined threshold for cloud coverage. For instance, the cloud avoidance model may determine the presence of clouds in a requested geographic region is below a defined threshold and determine an imaging target to cause a satellite system to generate command instructions to update the trajectory of the satellite such that the satellite passes over the geographic region (e.g., imaging target). In some examples, a flight control system of the satellite may determine that the satellite will not pass over the one or more targets based on a current trajectory and the cloud avoidance model may recompute the imaging targets and determine updated imaging targets. In some examples, the updated imaging target may cause the satellite system to generate command instructions to update the trajectory of the satellite such that the satellite will pass over the updated imaging targets.

Based on a determined cloud coverage, the system may generate and/or transmit a success metric or a failure metric. If a failure metric is generated because a high-priority target is obscured, the satellite may initiate a “tip-and-cue” workflow. For example, the primary satellite may transmit an imaging task payload (e.g., including the target location and required acquisition parameters) to a second imaging satellite, such as a second imaging satellite in the same constellation. Such transmission may be performed directly between the primary satellite and the second satellite, or via a relay satellite (LEO, MEO, geostationary, or other relay satellite configurations). This may the second satellite to adjust its own slew trajectory to attempt a capture from a different angle or using a different sensor, such as an LWIR camera or SAR sensor, which may be less impacted by environmental conditions. In some examples, transmitting the imaging task payload to a second imaging satellite may allow the second satellite to capture, or attempt to capture, an image of the target location more quickly, by avoiding the need for a new imaging task payload to be delivered, such as from a ground-based station.

The technology of the present disclosure may provide several benefits and technical effects. For instance, the technology of the present disclosure may optimize the trajectory of satellites tasked to perform satellite imagery by avoiding clouds to capture a higher percentage of usable satellite imagery and decreasing the number of orbits which yield unusable satellite imagery. As such, the technology may increase the flexibility of the satellite by allowing more agile trajectory generation that targets geographic regions which contain tolerable cloud coverage. The technology of the present disclosure may also help to increase the efficiency and management of a satellite system due to the blurring of image segments which reduce the number of features the cloud avoidance model must learn to detect and predict cloud coverage, thereby preserving limited power and computing resources. Moreover, by blurring image segments, the technology of the present disclosure may decrease the computing resources required to process sensor data and avoid the presence of clouds.

The technology of the present disclosure also improves the onboard computing technology of the satellite. For instance, the satellite may include limited power and computing resources to continuously operate the satellite throughout its lifetime. The model running on satellite system may obtain image data from the forward-looking sensor and fuse the image data with the metadata to produce more accurate input data for the model and improve the confidence level of the model. The model may segment the image data fused with the metadata and generate a box blur to blur the image segments. This may include blurring features of objects such as clouds depicted in the image segment. In this way, the model is limited in the number of features it must learn to detect the absence of clouds in an image frame. Accordingly, the satellite system can avoid wasting computing resources to power the model by more efficiently learning cloud features and processing image frames to detect the absence of clouds. In this way, the satellite computing system can more efficiently utilize its computing resources.

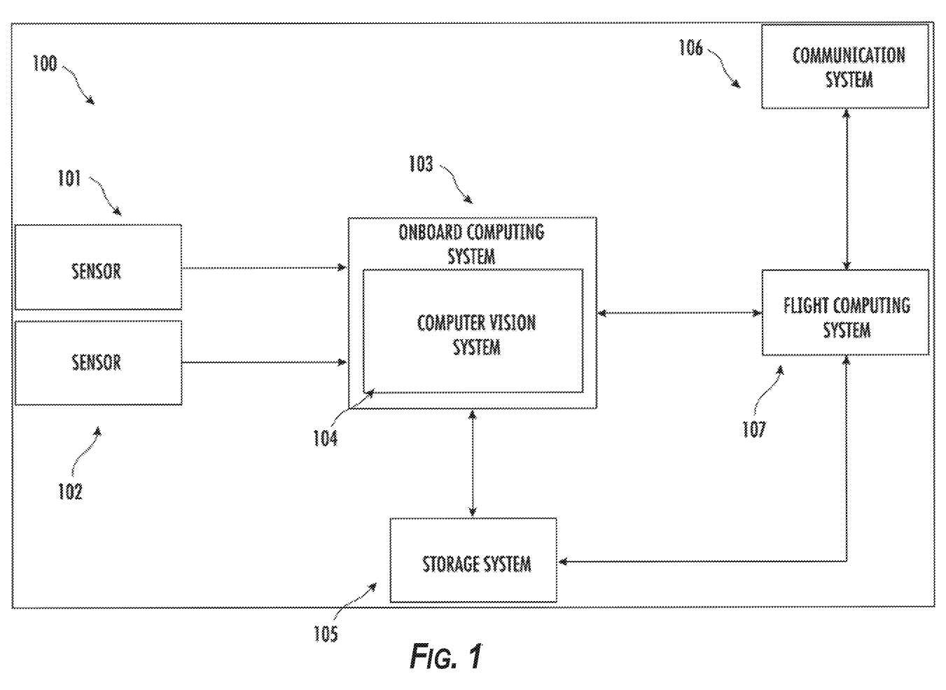

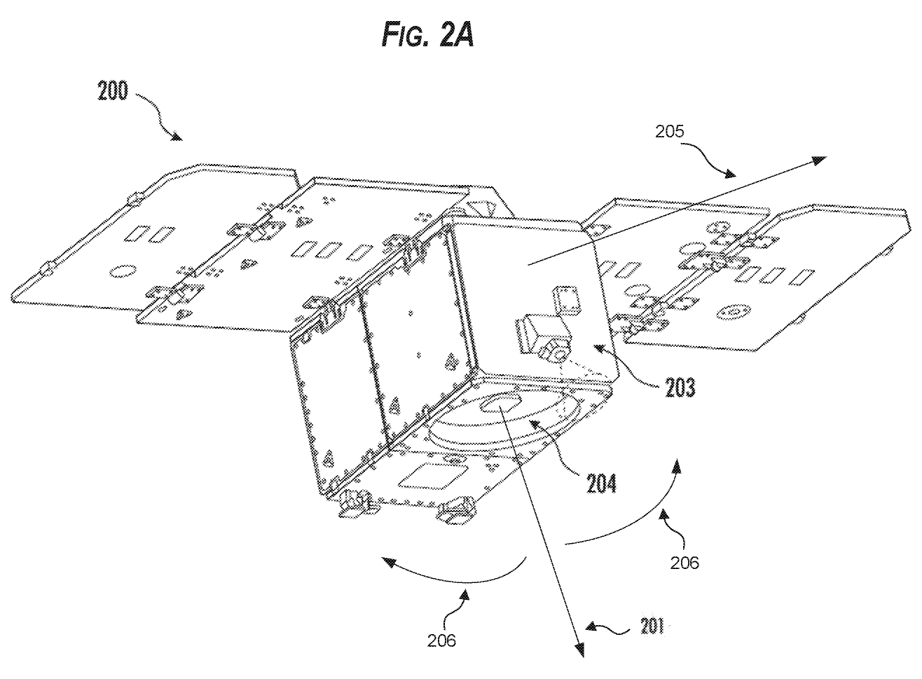

With reference now to the FIGS., example embodiments of the present disclosure will be discussed in further detail. FIG. 1 depicts an example satellite system according to example embodiments of the present disclosure. The satellite system 100 may include a number of subsystems and components for performing various operations. For example, the satellite system 100 may include sensors 101, 102, an onboard computing system 103, onboard storage system 105, a flight computing system 107, and a communication system 106. The satellite system 100 may be any computing device which is capable of exchanging data and sharing computing resources. For example, the satellite system 100 may include one or more devices configured to receive, store, or transmit data over physical or wireless technologies. In some examples, the satellite system 100 may include hardware and software. In other examples, the satellite system 100 may include physical devices connected to one or more networks. In some examples, the satellite system 100 may be any type of satellite (e.g., low-earth orbit satellites, medium earth orbit satellites, polar orbit satellites, etc.,) which orbits the Earth and is capable of acquiring imagery. In some examples, the satellite system 100 may be part of a constellation of imaging satellites that cooperatively share imaging task payloads to maintain near real-time monitoring of a subject of interest (SOI). The communication system 106 may be configured to facilitate these exchanges via inter-satellite links (directly or indirectly) or third-party relay networks.

The satellite system 100 may include sensors 101, 102. In some examples, the sensors 101, 102 may be cameras. For example, sensor 101 may be a VIS (visible imaging sensor) camera. A VIS camera may include a standard video camera packaged for flight use mounted in a downward oriented manner to provide a continuous view of geographic regions directly below the satellite. Sensor 102 may be a LWIR (long wave infrared) camera. A LWIR camera may include cameras capable of thermal imaging. While examples here describe the sensors 101, 102 as a VIS camera and a LWIR camera, the sensors 101, 102 may include additional types of cameras such as NIR (near-infrared), SWIR (short-wave infrared), MWIR (mid-wave infrared), etc. In some examples, sensors 101, 102 may be a combination of sensors described herein.

In some examples, the satellite system 100 may include an onboard computing system 103. For instance, the sensors 101, 102 may be connected to the onboard computing system 103. In some examples, the sensors 101, 102 may be connected via a USB (universal serial bus). In some examples, the sensors 101, 102 may be connected via a MIPI (mobile industry processor interface) interface. For example, a MIPI interface may include a camera module or system which transmits an image from the sensors 101, 102 and stores the image in memory (e.g., storage system 105) as individual frames. In other examples, the sensors 101, 102 may be connected to the onboard computing system 103 via any wired or wireless connection such as Bluetooth, SDIO, USB-A, USB-C, etc.

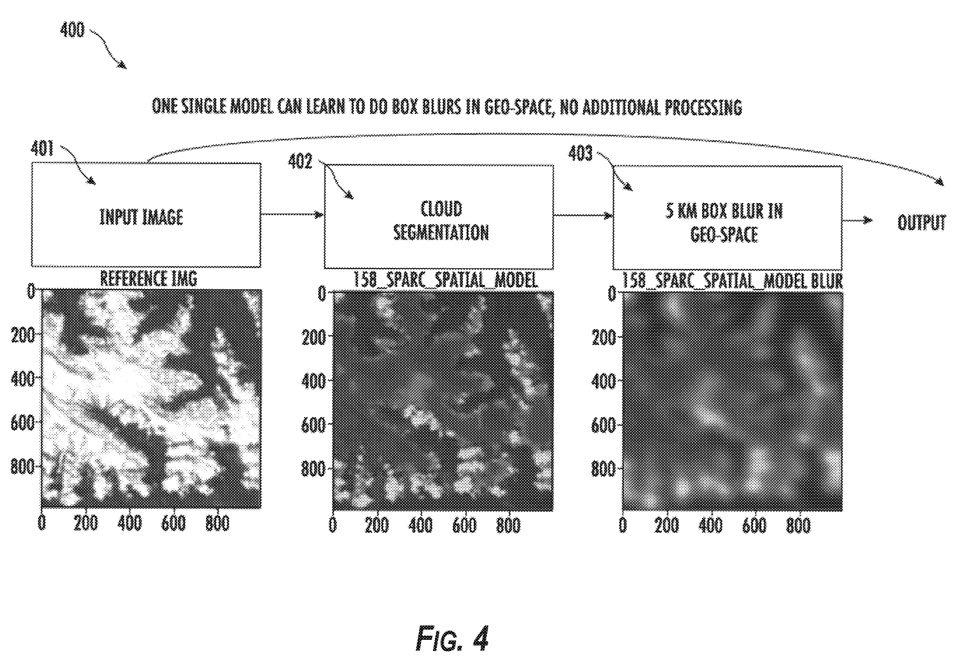

The onboard computing system 103 may include a number of subsystems and components for performing various operations. For example, the onboard computing system 103 may include a computer vision system 104. The computer vision system 104 may include any computing device which is capable of running computer vision applications. For instance, the computer vision system 104 may include one or more devices configured to perform tasks such as image classification, image segmentation, object detection, etc. In some examples, the computer vision system 104 may include hardware and software. For instance, the computer vision system 104 may include models which process sensor data captured by the sensors 101, 102. An example of the computer vision system 104 processing sensor data is further described with reference to FIGS. 3-4.

The satellite system 100 may include a storage system 105. For instance, the onboard computing system 103 may be connected to the storage system 105. The storage system 105 may include one or more storage devices for storing data. For example, the storage system 105 may include an electronic storage device, a magnetic storage device, an optical storage device, an electromagnetic storage device, a semiconductor storage device, or any suitable combination for storing data. In some examples, the onboard computing system 103 may be connected to the storage system 105 via a wired or wireless connection. For instance, the onboard computing system 103 may be connected to the storage system 105 via an ethernet cable. In some examples, the onboard computing system 103 and storage system 105 may be connected via a Gigabit Ethernet cable. In other examples, the onboard computing system 103 and storage system 105 may be connected over a wireless connection such as Bluetooth, SDIO, etc.

The onboard computing system 103 may transmit and store data in the storage system 105 over a connection (e.g., ethernet, Gig Ethernet, etc.). By way of example, the sensors 101, 102 may receive sensor data and transmit the sensor data over one or more connections to the onboard computing system 103. In some examples, the computer vision system 104 may perform one or more computer vision tasks and transmit the processed sensor data to the storage system 105 for storage. For instance, the storage system 105 may include data stores such as relational databases, non-relational databases, key-value stores, full-text search engines, message queues, etc. In some examples, the computer vision system 104 may store and retrieve data within the storage system 105 over a wired or wireless connection.

In some examples, the storage system 105 may store data associated with one or more satellites in a satellite constellation. Data associated with the satellites may include a schedule indicative of the pending image acquisition commands/sequences of a given satellite or group of satellites. In some examples, the data associated with the satellite may include data indicative of the past, present, and/or future trajectory of the satellite(s). In some examples, the data associated with the satellites may include information associated with the power resources (e.g., power level, etc.), memory resources (e.g., storage availability, etc.), communication resources (e.g., bandwidth), etc. of the satellite(s). In some examples, the data associated with the satellites may include health and maintenance information associated with the satellite(s) (e.g., maintenance schedules, damage reports, other status reports, etc.). In other examples, the data associated with the satellite may include data indicative of the type and/or status of the hardware (e.g., antenna, communication interfaces, etc.) and/or software onboard a satellite (e.g., satellite system 100). Data associated with the satellites may further include “tip-and-cue” instruction sets received from other satellites in the constellation, or satellites in other constellations. For instance, the storage system 105 may house a shared imaging schedule that is updated when a first satellite “cues” a second satellite to adjust its trajectory due to detected cloud obstructions.

The satellite system 100 may include a flight computing system 107. For instance, the onboard computing system 103 and flight computing system 107 may transmit data over one or more wired or wireless connections such as Ethernet, Bluetooth, etc. The flight computing system 107 may include different subsystems, software, and hardware for performing various flight control operations. For example, the subsystems may include flight controllers for controlling a motion of the satellite system 100. Example flight controllers may include propulsion thrusters, reaction wheels, etc. By way of example, the flight computing system 107 may receive electrical signals over one or more connections from the onboard computing system 103. For instance, the flight computing system 107 may be configured to implement translated controls (e.g., electrical signals) from the onboard computing system 103. In some examples, the flight computing system 107 may implement operations to flight controllers of the satellite system 100 to adjust a trajectory of the satellite.

In some examples, the flight computing system 107 may include satellite flight software and an execution model to support a communication pathway with the communication system 106. In some examples, the flight computing system 107 may include software to support hardware in a translation layer (e.g., providing a highly efficient packet protocol), a commanding interface to utilize a low bandwidth channel (e.g., 10s bits/second), an interface to sequence loading, module(s) for attitude control system (ACS) target tracking, a module for image (IMG) captures, module(s) for emergency commanding, module(s) for real time telemetry feedback for critical satellite states, module(s) for providing the ability to change pathway settings autonomously based on position (e.g., GPS, etc.) and a specific geostationary satellite footprint that has the best line-of-sight (LOS) for the satellite system 100 to encode/decode data transmitted via the communication system 106, etc.

In some examples, the flight computing system 107 may transmit data over one or more connections to the onboard computing system 103. For instance, data such as health and maintenance information associated with the flight computing system 107 may be transmitted to the onboard computing system 103. In some examples, the data such as the current trajectory of the satellite may be transmitted to the onboard computing system 103. By way of example, the flight computing system 107 may receive electrical signals to adjust a trajectory of the satellite. The flight computing system 107 may determine the satellite has insufficient power/resources to implement the controls or determine, based on its current trajectory, there is insufficient time to implement the controls. In some examples, the flight computing system 107 may transmit response data indicating the current trajectory of the satellite and resources are insufficient to implement controls.

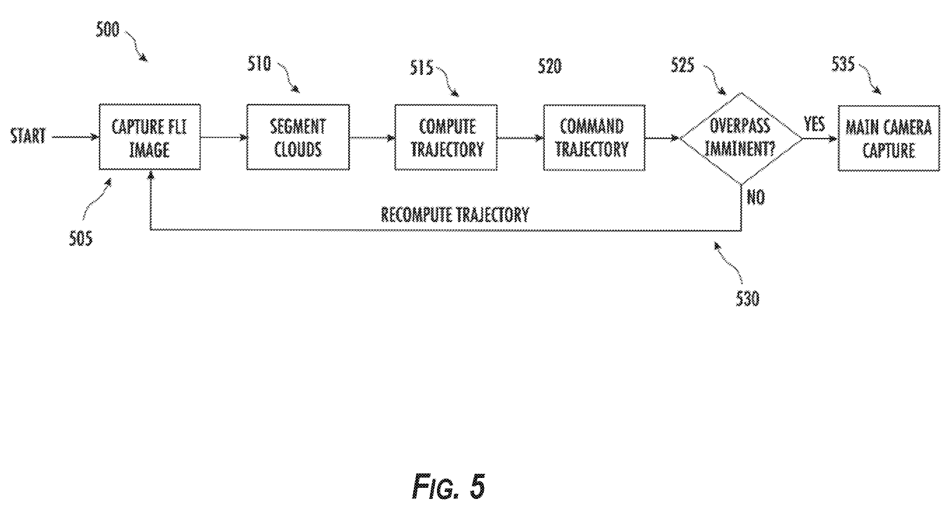

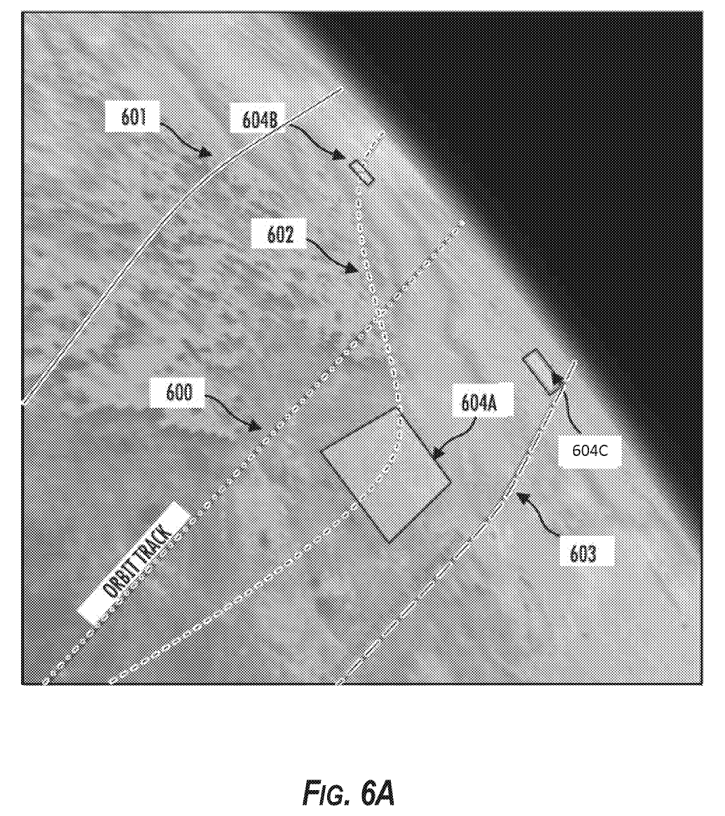

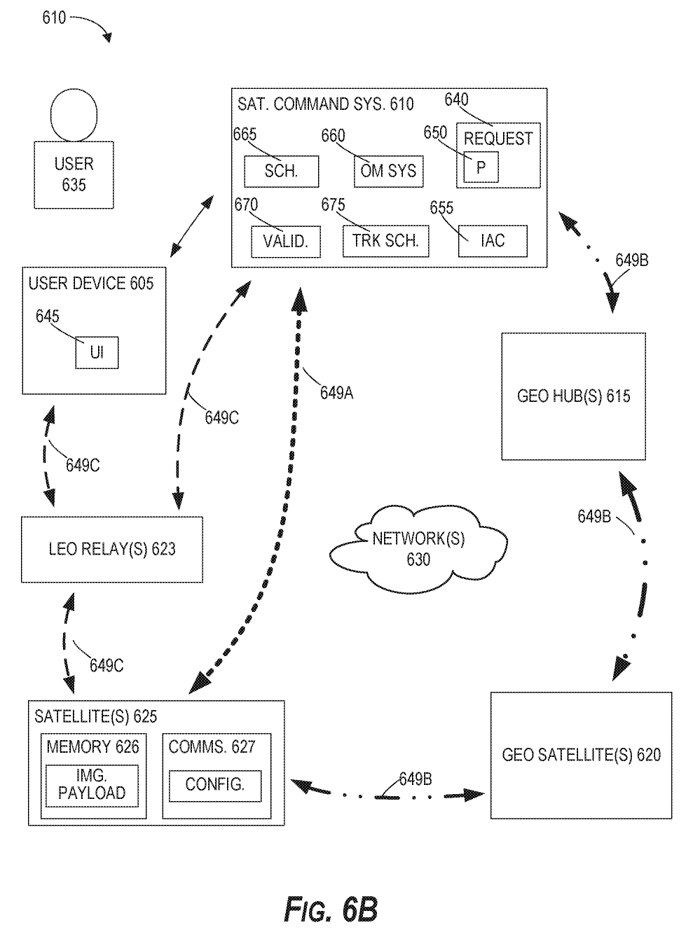

In some examples, the flight computing system 107 may transmit and store data in the storage system 105 over a connection (e.g., ethernet, Gig Ethernet, etc.). For instance, the flight computing system 107 may be connected to the storage system 105 via a wired or wireless connection. By way of example, the flight computing system 107 may receive one or more electrical signals to control a motion of the satellite. The flight computing system 107 may implement the operations and transmit data over the connection to the storage system 105. For instance, the flight computing system 107 may transmit current trajectory data, an updated trajectory of the satellite after adjusting the trajectory of the satellite, etc. In some examples, the data stored in the storage system 105 may also be accessible by the onboard computing system 103. For instance, the onboard computing system 103 may utilize data (e.g., trajectory data) generated by the flight control system 107 and stored in the storage system 105 for processing sensor data to generate updated trajectories for the satellite. An example of the onboard computing system 103 utilizing data generated by the flight computing system 107 to generate updated trajectories is further described with reference to FIG. 5.

The satellite system 100 may include a communications system 106. The communication system 106 may include hardware and software configured to communicate with remote systems and devices. For instance, the communication system 106 may include antennas that allow the communication system to utilize RT (real time/near real time) communication pathways. RT communication pathways may include a communication pathway via which an image acquisition command is sent directly to the satellite system 100. For instance, a signal may be sent from a ground station to the satellite system 100 when the orbital access and pointing/range requirements of that pathway are met (e.g., when the satellite is in an orbit position to receive a transmission from a ground-based command center). In some examples, the antennas may include an omnidirectional antenna that may be configured to close a link for tasking. In some examples, the communication system 106 may include a phased array antenna (e.g., for higher data rates). In other examples, the communication system 106 may include two separate antennas for a forward and/or reverse link.

The communication system 106 may include one or more subsystems. The subsystem may include RF (radio frequency) interfaces to transmit (Tx) and/or receive (Rx) via antennas. In some examples, the communication system 106 may utilize full-duplex operation, such that the receiver is enabled at all times. The communication system 106 may utilize frequency separation f1, f2, etc. (e.g., 6 GHz/4 GHz Tx/Rx frequency separation) for effective isolation between the receiving (Rx) and transmitting (Tx) paths.

In some examples, the communication system 106 may include GEO communication infrastructure. Example GEO communication infrastructure may include a Very Small Aperture Terminal (VSAT). VSAT may include a two-way satellite communication system for communicating with a ground station (e.g., GEO hub(s)) or other satellites such as geostationary satellites. For instance, the communications system 106 may be integrated with a plurality of geostationary satellites with architecture for providing global coverage beams. By way of example, the communications system 106 may establish a network connection for the satellite system 100 by utilizing dedicated bandwidth from geostationary satellites and GEO hub(s). A link may be established to a particular satellite by selecting a corresponding geostationary satellite and GEO hub. As described herein, the GEO hub(s) may be ground stations with communication infrastructure for communication with the geostationary satellites. In some implementations, modems tuned to dedicated frequencies for the entity associated with the communication system 106 may be housed at the GEO hub(s).

In some examples, the communication system 106 may communicate with ground stations and receive a schedule indicative of the pending image acquisition (e.g., imaging targets) commands. For instance, the ground stations may be associated with a control center which receives requests for image acquisition from one or more third parties, directly from the satellite owner, or satellite operator. In some examples, the ground stations may identify a satellite which is available to acquire the requested imagery. In some examples, the ground station may transmit an acquisition command (e.g., radio signal translation, etc.) to the communication system 106.

The communication system 106 may be configured to obtain the image acquisition command (e.g., a radio signal translation, etc.) and transmit electrical signals over one or more connections to the flight computing system 107. For instance, the flight computing system 107 may be configured to implement translated controls (e.g., electrical signals) from the communication system 106. In some examples, the flight computing system 107 may implement operations to adjust a trajectory of the satellite and acquire the images. In some examples, the flight computing system 107 may store a schedule of pending image acquisitions (e.g., image requests) in the storage system 105. For instance, the onboard computing system 103 may access and process the schedule of pending image acquisitions. An example of the onboard computing system processing the schedule of pending image acquisitions is further described with reference to FIG. 3.

In some examples, the communication system 106 may utilize the RT communication pathways to downlink acquired imagery to a ground station. By way of example, the communication system 106 may receive image acquisition commands (e.g., imagery request) from a ground station. The flight computing system 107 may adjust, using flight controllers, the trajectory of the satellite system 100 to navigate to the geographic region specified by the image acquisition command. The sensors 101, 102 may acquire imagery which satisfies the image acquisition command and transmit the imagery to the onboard computing system 103. In some examples, the onboard computing system 103 may store the imagery in the storage system 105. In some examples, the flight computing system 107 may determine that the satellite system 100 is in an orbit position to downlink a transmission to a ground station center and the communication system 106 may downlink the requested imagery to the ground station.

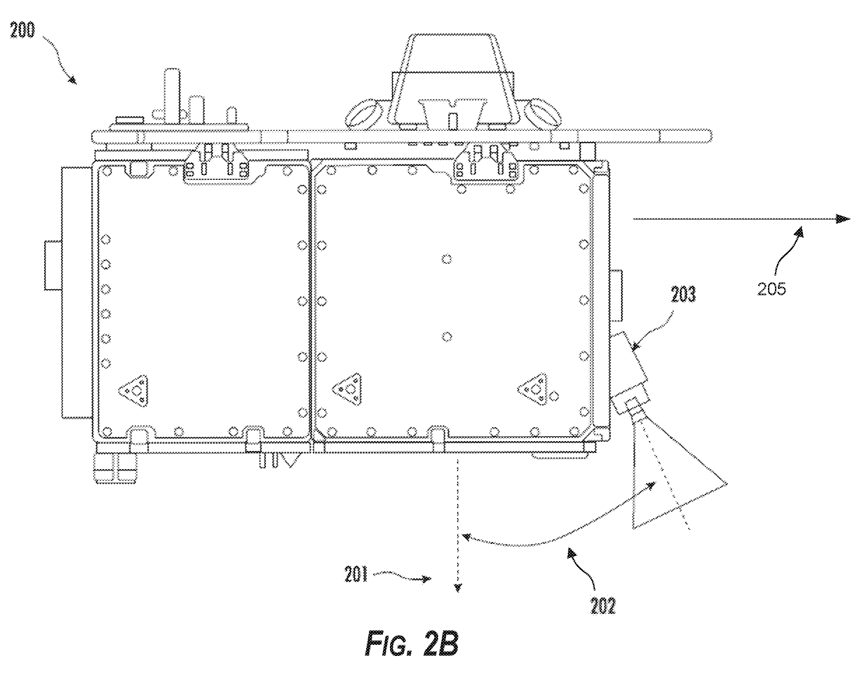

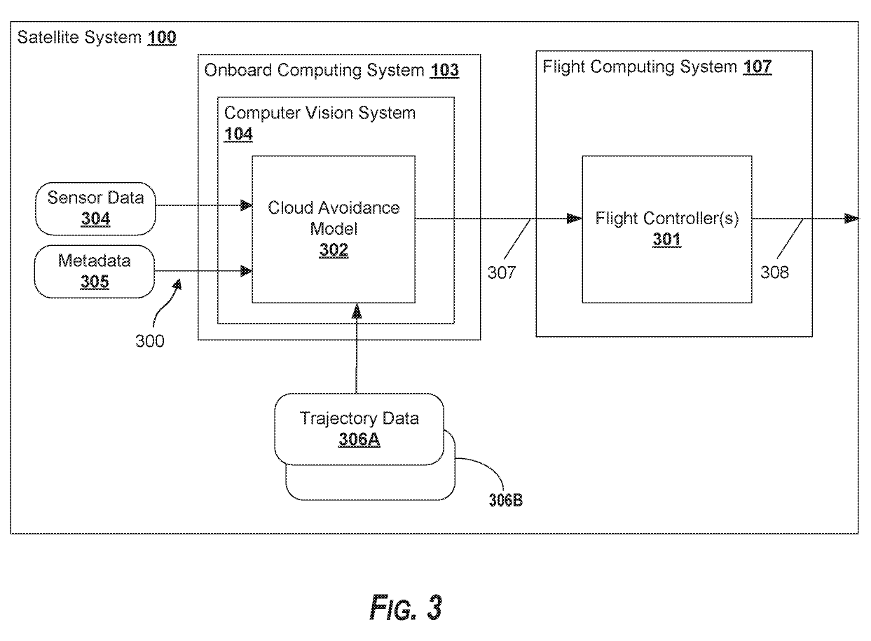

FIG. 2A-2B depicts an example satellite including a forward-looking sensor according to example aspects of the present disclosure. The example satellite 200 may include one or more physical components and instruments for performing various operations. The satellite 200 may be low earth orbit satellites, medium earth orbit satellites, polar orbit satellites, or any type of satellite capable of acquiring imagery. For instance, the satellite 200 may include a forward-looking sensor 203 affixed in a forward oriented position on a surface of the satellite 200. In some examples, the forward-looking sensor 203 may include a moveable sensor affixed to a surface of the satellite 200. In some examples, the forward-looking sensor 203 may be a camera sensor. The forward-looking sensor 203 may be VIS camera, LWIR camera, or any type of camera. In some examples, the forward-looking sensor 203 may be affixed to a front surface of the satellite 200. In other examples, the forward-looking sensor 203 may be affixed to any surface of the satellite 200 which allows for a look ahead angle 202. The look ahead angle 202 may be an angle relative to nadir or an optical axis 201 of a payload sensor of the satellite 200.

By way of example, the satellite 200 may orbit the Earth in an orbit path 205. The satellite 200 may include a payload sensor 204 which captures and transmits imagery of the Earth’s surface. In some examples, the payload sensor 203 may be a camera sensor. The payload sensor 203 may be VIS camera, LWIR camera, or any type of camera. In some examples, the payload sensor 203 may be affixed to a downward facing surface of the satellite 200. For instance, the payload sensor 204 may acquire imagery directly below or within a field of view of the satellite 200. In some examples, the payload sensor 204 may acquire imagery which satisfies image acquisition commands. The satellite 200, in its neutral state, may have the payload sensor 204 pointed directly towards the Earth’s surface, such that the payload sensor 204 captures images directly below the satellite 200 in its nadir field of view. The payload sensor 204 capturing imagery directly below the satellite is referred to as nadir. Conversely, the satellite 200 may be maneuverable such that the satellite 200 may have a slew trajectory 206 (i.e., tilt left or right relative to the orbit path 205) such that images may be captured which are not directly below the satellite- referred to as “off-nadir.” As such, by slewing the satellite 200, the optical axis 201 of the payload sensor 204 is moveable such that the field of regard of the payload sensor 204 exceeds the nadir field of view.

In some examples, the forward-looking sensor 203 may include a look ahead angle 202 of 25 degrees from the optical axis 201. The look ahead angle 202 may include a compound angle. For instance, the look ahead angle may include the slewing angle of the satellite 200 and the datum offset of the boresight of the forward-looking sensor 203. In some examples, the look ahead angle 202 may also include a portion (e.g., one half) of the look ahead sensor 203 field of view (FOV) such that the look ahead angle 202 aligns with the direct (LOS) line of sight of the forward-looking sensor 203. For instance, the forward-looking sensor 203 may include a FOV of 50 degrees. In some examples, the look ahead angle 202 may be a positive angle.

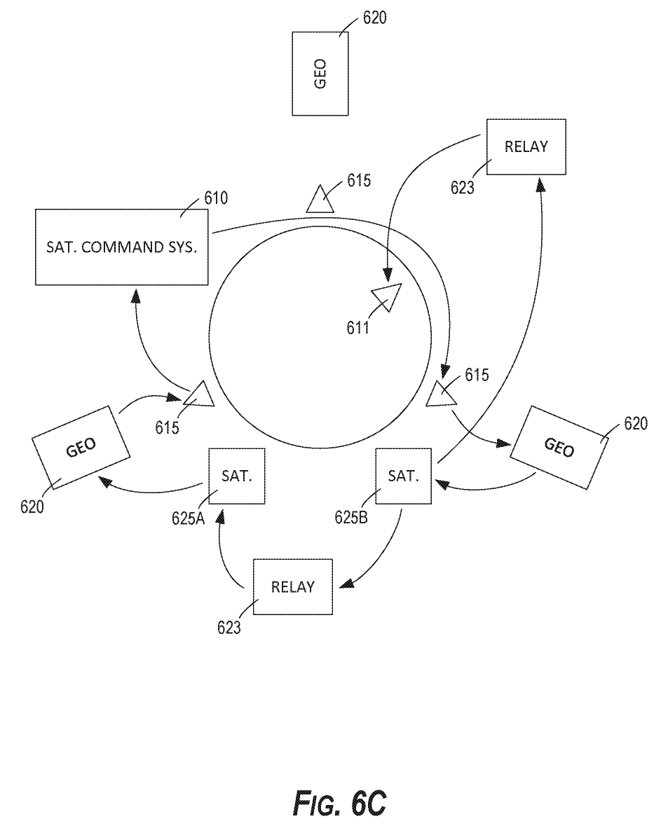

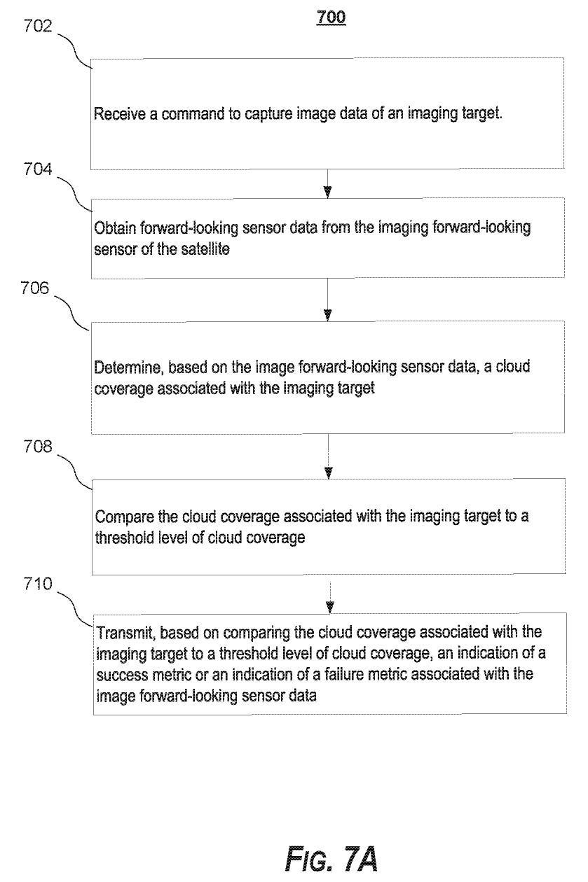

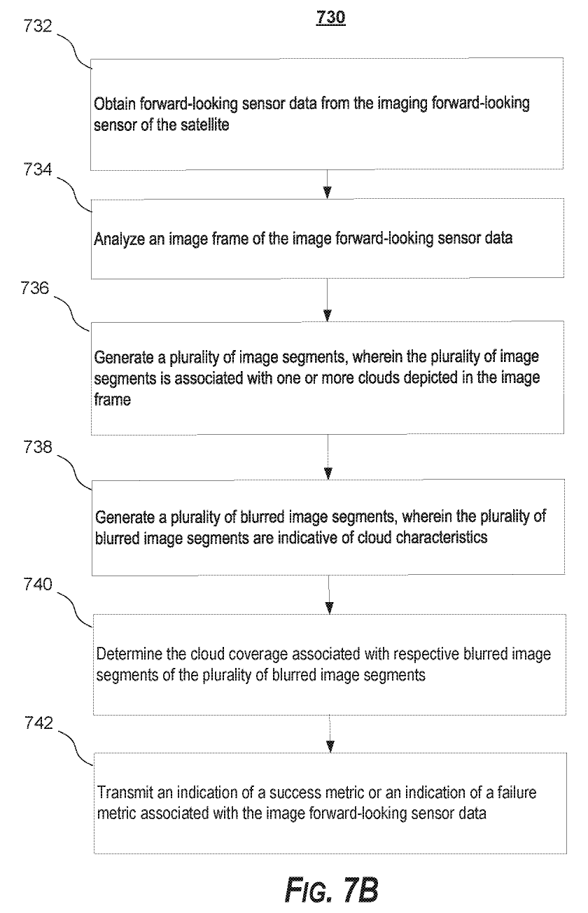

The satellite 200 may orbit the Earth on a slew trajectory using thrusters or reaction wheels (e.g., flight controllers). A slew trajectory 206 may allow the payload sensor 204 of the satellite 200 to have a moveable optical axis as the satellite 200 orbits the Earth. An example of a slew trajectory is further described with reference to FIG. 6. In some examples, the forward-looking sensor 203 may include a fish-eye field of view (e.g., wide field of view), such as 120 degrees or greater, such that the forward-looking sensor 203 can capture data that is not only within the future field of view of the payload sensor 204 when positioned on nadir, but also to capture imagery within the full future field of regard of the payload sensor when positioned off-nadir, thus encompassing the full range of geographic regions capable of being captured by a payload sensor of the satellite 200 within its potential (or capable) slew trajectory 206.

In some examples, the forward-looking sensor 203 may be configured to identify objects based on spectral bands. For instance, the forward-looking sensor 203 may include a SWIR and a LWIR sensor capable of detecting spectral bands. In some examples, the forward-looking sensor 203 may be configured to detect an object by detecting spectral bands associated with an object. For example, the forward-looking sensor 203 may identify an object as a cloud by detecting spectral bands (e.g., (1.36 -1.38µm, etc.) which correspond to a cloud.

In some examples, the forward-looking sensor 203 may acquire data indicative of the one or more geographic regions (e.g., imaging targets) ahead of the satellite 200 which have been scheduled for image acquisition. For instance, the forward-looking sensor 203 positioned at a 25 degree look ahead angle 202 may provide data indicative of more optimal imaging targets ahead of the satellite 200 based on the presence of clouds. For example, cloud coverage may obscure acquired images. The forward-looking sensor 203 positioned at a 25 degree look ahead angle 202 may provide timely data to one or more subsystems (e.g., onboard computing system 103, computer vision system 104, etc.) of the satellite 200 such that the satellite 200 may determine geographic regions ahead of the satellite 200 which are obscured by cloud cover and avoid the geographic regions which include cloud coverage. An example of a satellite utilizing sensor data captured by a forward-looking sensor 203 to avoid cloud coverage is further described with reference to FIG. 3.

FIG. 3 depicts a block diagram of an example data pipeline according to example aspects of the present disclosure. The following description of dataflow in data pipeline 300 is described with an example implementation in which the satellite system 100 utilizes a cloud avoidance model 302 to process sensor data 304, metadata 305, and trajectory data 306A, 306B to generate output 307 indicative of optimal imaging targets. The example implementation may also include flight controllers 301 which receive output 307 from the cloud avoidance model 302 and generate output 308 to control a motion of the satellite system 100. Additionally, or alternatively, one or more portions of data pipeline 300 may be implemented offboard the satellite system 100.

The satellite system 100 may include a cloud avoidance model 302 that utilizes the sensor data 304, metadata 305, and trajectory data 306A, 306B to determine imaging targets which avoid cloud coverage. In some examples, the cloud avoidance model 302 may be a machine-learned-model. In some examples, the cloud avoidance model 302 may be an analytical model, empirical model, or any combination thereof capable of making a prediction.

In an embodiment, the cloud avoidance model 302 may be an unsupervised learning model configured to detect, identify, and segment objects depicted in an image frame. In some examples, the cloud avoidance model 302 may include one or more machine-learned models. For example, the cloud avoidance model 302 may include a machine-learned model trained to detect objects in a specific context (e.g., clouds over bodies of water, over land, etc.). In some examples, the cloud avoidance model 302 may include a machine-learned model trained to distinguish clouds from other objects such as snow, ice, or ocean foam by executing segmentation techniques.

The cloud avoidance model 302 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The cloud avoidance model 302 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using labeled training data. As further described herein, the training data may include labeled image frames that have labels indicating cloud coverage and the segmentation of clouds (e.g., isolated clouds, storm/weather systems, etc.). In some examples, the training data may include simulated training data (e.g., training data obtained from simulated scenarios, inputs, configurations, previous satellite orbits, etc.).

Additionally, or alternatively, the model trainer(s) may perform unsupervised training techniques using unlabeled training data. By way of example, the model trainer(s) may train one or more components of a machine-learned model to execute cloud avoidance through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The cloud avoidance model 302 may obtain sensor data 304 from one or more sensors 101,102 of the satellite system 100. In some examples, the sensor data 304 may include image data. In some examples, the sensor data 304 may include video data. In some examples, the sensor data 304 may include image data captured by the forward-looking sensor 203. For instance, the cloud avoidance model 302 may obtain sensor data 304 including image data from the forward-looking sensor 203 depicting geographic regions ahead of the satellite system 100. For example, the satellite system 100 may be traveling along a current trajectory and the forward-looking sensor 203 may acquire sensor data 304 (e.g., image data, video data, etc.,) depicting geographic regions in the path of travel of the satellite 200 (e.g., satellite system 100).

In some examples, the sensor data 304 may include one or more image frames. For instance, the current trajectory data 306A of the satellite (e.g., satellite system 100) may be associated with scheduled image acquisitions. The scheduled image acquisitions may indicate requests for imagery of a specific geographic region (e.g., imaging targets). In some examples, the forward-looking sensor 203 may obtain sensor data 304 including one or more image frames depicting imaging targets scheduled for image acquisition ahead of the satellite system 100. By way of example, the satellite system 100 may be traveling along a current trajectory and the forward-looking sensor 203 may obtain sensor data 304 (e.g., one or more image frames) depicting imaging targets scheduled for image acquisition.

The cloud avoidance model 302 may access metadata 305 associated with one or more environmental conditions. Metadata 305 may include additional data which improves the accuracy of sensor data 304 or confidence level of the cloud avoidance model 302. For example, metadata 305 may include map data of historical cloud cover, monthly snow maps, land cover classifications, camera temperatures, sun angle, time of day, or altitude. Metadata may include any data which may be used to increase the accuracy of sensor data 304 or improve the confidence level of the cloud avoidance model 302. By way of example, sensor data 304 may include one or more image frames of a geographic region which depicts white cloud-like formations. Metadata 305 including a map of historical cloud cover may indicate a consistent pattern of cloud coverage over the geographic region. In some examples, the metadata 305 including the historical cloud cover may improve a confidence level determination of the cloud avoidance model 302 that the white cloud-like formation depicted in the sensor data 304 includes cloud coverage.

In some examples, the cloud avoidance model 302 may fuse the sensor data 304 and metadata 305. For instance, the cloud avoidance model 302 may be trained to detect the presence of clouds in an image frame. In some examples, the cloud avoidance model 302 may fuse the sensor data 304 and metadata 305 to identify additional features within the image frames which may increase the accuracy of the sensor data 304. In some examples, fusing the sensor data 304 and metadata 305 may compensate for environmental factors which may result in inaccurate identification of clouds. For instance, fusing the sensor data 304 and metadata 305 may help improve focal loss.

Metadata 305 may include any data which may adversely impact sensor data 304 or the sensors 101, 102. For instance, metadata 305 may include the camera (e.g., sensors 101, 102) temperature, sun angle, Earth surface angle, and slew angle may be fused with sensor data 304 to improve the accuracy of the sensor data 304. Sensor temperature metadata may include the temperature inside the satellite itself, the temperature of the geographic region detected by the sensor 101, 102, or any combination thereof. By way of example, sensor data 304 including an image frame of a geographic region may depict a bright cloud-like formation. In an embodiment, the cloud avoidance model 302 may fuse sensor data 304 with sensor temperature metadata indicating temperatures of the geographic region are below freezing. For instance, the sensor 102 may be a LWIR sensor capable of thermal imaging. The cloud avoidance model 302 may identify the bright cloud-like formation as snow or ice rather than a cloud based on the sensor temperature metadata. In another example, sensor temperature metadata may include a temperature of the payload sensor 204. For instance, the payload sensor may become hot causing adverse impacts to image quality.

In an embodiment, the cloud avoidance model 302 may fuse sensor data 304 with sun angle metadata, Earth surface metadata, and slew angle metadata. For instance, the flight computing system 107 may determine, based on its orbit position, the sun angle, Earth surface angle, and slew angle relative to the forward-looking sensor 203. In some examples, the angle at which the image frame was captured may result in varying brightness, exposure, shadows, density, contrast, saturation, etc. The cloud avoidance model 302 may more accurately identify the bright cloud-like formation as cloud cover rather than a reflection of light from land or other objects based on the sun angle metadata, Earth surface metadata, and slew angle metadata.

The cloud avoidance model 302 may access current trajectory data 306A indicating a current trajectory of the satellite (e.g., satellite system 100). In some examples, current trajectory data 306A may include the current speed, orbital position, or planned waypoints for the satellite. In some examples, the current trajectory data 306A may be transmitted over one or more connections from the flight computing system 107. In some examples, the current trajectory data 306A may be accessed from the storage system 105. For instance, the flight computing system 107 may actively store current trajectory data 306A in the storage system 105 where the onboard computing system 103 may access.

In some examples, the current trajectory data 306A may be associated with imaging targets (e.g., geographic regions). For instance, the current trajectory data 306A may indicate an orbit path or waypoint which passes over imaging targets scheduled for image acquisition. In some examples, the cloud avoidance model 302 may associate image frames included in sensor data 304 with geographic regions (e.g., imaging targets) which are scheduled for image acquisition. For instance, the cloud avoidance model 302 may fuse sensor data 304 and metadata 305 associated with imaging targets to determine whether the imaging targets scheduled for image acquisition include cloud coverage.

In some examples, the cloud avoidance model 302 may fuse the sensor data 304 and metadata 305 and process the image frames to determine cloud coverage associated with the imaging targets scheduled for image acquisition. For instance, as shown in FIG. 4 the cloud avoidance model 302 may receive an input image 401. Input image 401 may be sensor data 304 captured by a forward-looking sensor 203 of the satellite. In some examples, the input image 401 may include an image frame fused with metadata 305. In some examples, the cloud avoidance model 302 may perform cloud segmentation 402 techniques to segment the input image 401 based on the presence of clouds depicted in the image frame. In some examples, the cloud avoidance model 302 may perform cloud segmentation 402 techniques to segment the input image 401 based on imaging targets. For instance, the input image 401 may include a plurality of imaging targets and the input image 401 may be segmented based on the respective imaging targets. In some examples, the segmented image frames may include one or more objects (e.g., clouds). For instance, the segmented image frames may be analyzed to avoid cloud coverage.

Cloud segmentation 402 techniques may include analyzing the sensor data 304 (e.g., input image frame 401) fused with the metadata 305 and projecting a bounding shape on the image frame. A bounding shape may be any shape (e.g., polygon) that includes one or more imaging targets. Additionally, or alternatively, a bounding shape may include a shape that matches the outermost boundaries and contours of those boundaries for an imaging target. One of ordinary skill in the art will understand that other shapes may be used such as circles, squares, rectangles, etc. In some examples, the bounding shape may be generated on a per pixel level.

The cloud avoidance model 302 may perform cloud segmentation 402 to segment the input image 401 based on detecting one or more imaging targets and generate a box blur 403 to blur the input image 401 (e.g., image segments). The box blur 403 may include a blur filter encapsulating the image segment. In some examples, the box blur 403 may include a spatial domain linear filter. In some examples, the box blur 403 may reduce the clarity or sharpness of the input image 401. For instance, the cloud avoidance model 302 may employ a blur kernel (e.g., small matrix of numbers) to each pixel in the input image 401. The box blur 403 may include any image blurring technique such as Gaussian blur, defocus blur, motion blur, etc.

In some examples, the cloud avoidance model 302 may generate a box blur 403 to blur portions of the image segments. In some examples, the cloud avoidance model 302 may generate a box blur 403 to blur the entire image segment. For instance, the box blur 403 may blur a 5 km (kilometer) portion of the image segment. In some examples, the cloud avoidance model 302 may perform cloud segmentation 402 to segment the input image 401 into 5 km image segments. In some examples, the box blur 403 may be any dimensions such as 10 km, 20 km, etc. While examples here describe the blur box 403 as a post-processing operation, the cloud avoidance model 302 may also generate the blur box 403 during cloud segmentation 402 as a single operation.

The cloud avoidance model 302 may analyze the blurred image segments and determine one or more characteristics indicative of cloud coverage. For instance, the cloud avoidance model 302 may generate characteristics data (e.g., labels) that correspond to the characteristics of the bounding shape. Labels may include the classification of objects (e.g., land, water, etc.), the type of objects (e.g., clouds, snow, ocean foam, etc.), density, etc. In some examples, the characteristics data (e.g., labels) may indicate the presence of clouds in the blurred image segment. In some examples, the characteristics data may indicate the absence of clouds in the blurred image segment. In some examples, the box blur 403 may reduce the characteristics data needed to identify cloud coverage or the absence of clouds.

By way of example, the cloud avoidance model 302 may analyze the blurred image segments and label blurred objects within the blurred image frame based on fused metadata 305. For instance, the cloud avoidance model 302 may label a bounding shape which includes a blurred white cloud-like object as a cloud due to sensor temperature metadata indicating the temperature of the blurred white cloud-like object matches a temperature range typical of a cloud (e.g., cloud characteristic) in the geographic region. In some examples, the cloud avoidance model 302 may determine the blurred white cloud-like object is a cloud and generate a cloud label to indicate the presence of clouds.

In some examples, the cloud avoidance model 302 may determine an absence of clouds within the blurred image frame based on fused metadata 305. By way of example, the cloud avoidance model 302 may analyze a blurred image segment and label a bounding shape which includes a white cloud-like object as cloudless due to sun angle metadata and slew angle metadata which indicates the white cloud-like object appearance is a result of sunlight reflecting off a snow or ice surface. In some examples, cloud avoidance model 302 may determine the blurred image frame does not include cloud coverage and generate a cloudless label to indicate the absence of clouds.

In other examples, the cloud avoidance model 302 may determine a level of cloud cover depicted in a blurred image frame and generate a label indicating the level of cloud cover. For instance, the cloud avoidance model 302 may generate a cloud coverage level label. In some examples, the cloud coverage level label may be associated with a cloud label. In other examples, the cloud coverage level label may be nested within a cloud label. The cloud coverage level may be a percentage, ratio, or any measure of cloud coverage relative to the blurred image frame (e.g., geographic target). By way of example, the cloud avoidance model 302 may analyze a blurred image segment and detect the presence of clouds. In some examples, the cloud avoidance model 302 may determine a level of clouds within the blurred image frame. Determining a level of clouds may include determining the percentage of pixels associated with the detected cloud relative to the bounding shape within the blurred image segment. In some examples, the cloud avoidance model 302 may determine based on metadata 305 the level of cloud coverage within the blurred image frame. For instance, Earth surface angle metadata may indicate that the detected clouds are not dense enough to obscure an image acquisition. In some examples, the level of cloud coverage may be determined based on metadata 305 indicating the density of clouds depicted in the blurred image segment.

In some examples, the cloud avoidance model 302 may detect clouds within the blurred image segment and generate a cloud coverage level label to indicate the level of cloud coverage. The cloud coverage level label may include an integer value, percentage value, ratio, or any value which indicates a consistent measure of cloud coverage.

Returning to FIG. 3, the cloud avoidance model 302 may determine based on current trajectory data 306A and sensor data 304 (e.g., image data) fused with metadata 305, one or more imaging targets and cloud coverage associated with the imaging target. For instance, the cloud avoidance model 302 may associate sensor data 304 (e.g., input image 401) with an imaging target based on current trajectory data 306A. The cloud avoidance model 302 may determine based on labeled blurred image segments the presence of clouds and the percentage of cloud coverage within the blurred image segment.

In some examples, the cloud avoidance model 302 may determine a comparison between the cloud coverage associated with an imaging target and a threshold level of cloud coverage. For instance, the current trajectory data 306A may include data associated with a cloud threshold or tolerance level for respective imaging targets. For example, the current trajectory data 306A, may indicate imaging targets scheduled for image acquisition.

In some examples, the imaging targets scheduled for image acquisition may indicate additional acquisition parameters. For instance, the imaging targets may indicate a cloud threshold or tolerance level to satisfy the acquisition request. By way of example, a cloud threshold or tolerance level of 30% may require that the acquired image contain no more than 30% cloud coverage to satisfy the image acquisition request. In some examples, the additional acquisition parameters may include a cost associated with the image acquisition. A cost may include commercial factors such as failure of previous attempts to acquire imagery, client value (e.g., priority of clients), or any other strategic prioritization rationale.

For instance, the cloud avoidance model 302 may determine a failure cost acquisition parameter associated with the image acquisition. The failure cost may include a generated integer or percentage value representing previous attempts associated with the image acquisition. In some examples, the failure cost may be any quantified representation of a previous failure associated with the image acquisition of a geographic region.

In some examples, the cloud avoidance model 302 may determine a client value acquisition parameter. The client value acquisition parameter may include a priority of clients (e.g., large clients, medium clients, small clients, etc.). For instance, large clients may include clients which generate large quantities of image acquisition requests. In some examples, large clients may be associated with a high priority acquisition parameter to indicate a higher priority for image acquisition requests associated with the large client. In other examples, small or medium clients may be associated with a lower priority acquisition parameters to indicate the lower priority of image acquisition requests associated with the small or medium clients.

In other examples, the image acquisition parameters may include other relationship considerations. For instance, the image acquisition parameter may include strategic reasons for prioritizing an image acquisition request. For example, the image acquisition requests may be associated with a new client. In some examples, new clients may be associated with a high priority image acquisition parameter to display an ability to satisfy future image acquisition requests for the new client. The image acquisition parameters may include any other strategic reason for prioritizing an image acquisition request.

In some examples, geography may also be considered. Geographic regions which are more difficult to acquire imagery that satisfies a cloud threshold or tolerance level may be associated with a higher cost than other geographic regions due to the increased difficulty. In addition, a priority may be placed on certain geographic regions that rarely satisfy a cloud threshold or tolerance level, and thus may be prioritized in circumstances where the cloud threshold is met.

In other examples, the additional acquisition parameters may include a time parameter. The time parameter may indicate that the requested image must be acquired within a specified time period. By way of example, the time parameter may indicate that imagery be acquired within 72 hours from request.

The cloud threshold or tolerance level may include an integer value, percentage value, or any value which indicates a consistent measure of cloud coverage. In some examples, the cloud threshold or tolerance level may include an upper limit threshold, lower limit threshold or an exact threshold or tolerance level. In some examples, satisfying the threshold or tolerance level may include cloud coverage level above the cloud threshold, below the cloud threshold or exactly matching the cloud threshold.

The cloud avoidance model 302 may compare the cloud coverage level label of the blurred image segment to the cloud threshold or tolerance level for the requested imagery of the geographic region and determine imaging targets which satisfy the cloud threshold acquisition parameter. By way of example, the cloud avoidance model 302 may receive sensor data (e.g., input image 401), perform cloud segmentation 402 to segment the input image 401, generate a box blur 403 to blur the image segment, and label the blurred image segment. In some examples, the cloud avoidance model 302 may identify a first cloud and a second cloud covering a first and second geographic region (e.g., imaging targets) scheduled for image acquisition based on labelling blurred image segments. In some examples, the cloud avoidance model 302 may determine the cloud coverage level associated with the first and second imaging targets within the blurred image segments based on labelling the blurred image segment. The cloud avoidance model 302 determine based on current trajectory data 306A that the first imaging target includes a cloud threshold acquisition parameter of 10% and the second imaging target includes a cloud threshold acquisition parameter of 40%. The cloud avoidance model 302 may compare the cloud level labels for the respective imaging targets and determine the first imaging target should be avoided due to a cloud coverage label indicating 20% cloud coverage and a cloud coverage label indicating 25% cloud coverage for the second imaging target.

In some examples, the cloud avoidance model 302 may determine both first and second imaging targets satisfy their respective cloud threshold acquisition parameters and prioritize imaging targets based on other acquisition parameters. For instance, an imaging target may be associated with a time parameter that will be exceeded if the image is not acquired during the current orbit. In some examples, a cost acquisition parameter may influence priority of imaging targets which satisfy cloud threshold acquisition parameters. For instance, a first image acquisition may be valued higher than second image acquisition based on commercial factors (e.g., failure, client value, etc.) and may increase the priority of the imaging target and the cloud avoidance model 302 may determine the first imaging target should be acquired instead of the second imaging target.

The cloud avoidance model 302 may determine imaging targets which satisfy the cloud threshold acquisition parameters and transmit the imaging targets to the flight computing system 107 to generate an updated trajectory. For instance, the current trajectory data 306A may indicate that the current trajectory of the satellite (e.g., satellite system 100) will not pass over the imaging targets which satisfy the cloud threshold acquisition parameters (e.g., avoid cloud covered imaging targets). The cloud avoidance model 302 may generate output 307 indicative of the imaging targets that satisfy the cloud threshold acquisition parameters. In some examples, the cloud avoidance model 302 may transmit output 307 to the flight controller 301 of the flight computing system 107. In some examples the flight controllers 301 may be configured to receive the output 307. For instance, the output 307 may include one or more electrical signals.

By way of example, the flight controllers 301 of the flight computing system 107 may receive output 307 (e.g., electrical signals) over one or more connections from the cloud avoidance model 302 of the computer vision system 104. For instance the flight computing system may be configured to implement translated controls (e.g., electrical signals) from the computer vision system 103. In some examples, the flight computing system 107 may be configured to receive output 307 indicative of imaging targets and determine an updated trajectory. For instance, the current trajectory of the satellite system 100 may not include a way point or slew trajectory which passes over the imaging target indicated by the output 307. The flight computing system 107 may implement the output 307 by computing an updated trajectory and implementing operations to flight controllers 301. For instance, the flight controllers 301 may generate output 308 to control a motion of the satellite system 100. For example, the output 308 may include one or more command instructions to control a motion of the satellite based on the updated trajectory.

In some examples, the flight computing system 107 may determine the output 307 received from the cloud avoidance model 302 cannot be executed. For instance, the flight computing system 107 may determine, based on the current position, orbital speed, slew angle, etc. that navigating to an imaging target indicated by the output 307 results in a low probability of reaching the imaging target. For instance, the satellite system 100 may orbit the Earth at thousands of miles per hour and updating the trajectory may require sufficient time to maneuver without missing the imaging target. In some examples, the flight computing system 107 may determine the output 307 indicative of an updated trajectory is not possible or has a low probability of passing over the imaging target and generate updated trajectory data 306B accessible by the cloud avoidance model 302 to recompute the output 307 (e.g., imaging targets). Passing over the imaging target may include aligning the payload sensor 204 with the imaging target. In some examples, passing over the imaging target may include aligning the payload sensor 204 with a field of view (e.g., off-nadir) of the imaging target. An example, of the cloud avoidance model 302 recomputing output 307 is further described with reference to FIG. 5

In some examples, the flight computing system 107 may determine the output 307 indicative of an updated trajectory is not possible or has a low probability of acquiring off-nadir imagery and generate updated trajectory data 306B accessible by the cloud avoidance model 302 to recompute the output 307. For instance, the payload sensor 204 may acquire imagery which is not directly below the satellite 200 as the satellite 200 slews. In some examples, the imaging target may be outside of the field (e.g., off-nadir) of view of payload sensor 204. For instance, sensor data 304 captured by the forward-looking sensor 203 may include the geographic regions in the field of view of the payload sensor 204 based on the current position, orbital speed, slew angle, etc. of the satellite 200 (e.g., satellite system 100). As the satellite 200 orbits the earth the position, orbital speed, slew angle, etc. may change such that the output 307 indicative of an updated trajectory is not possible or has a low probability of acquiring off-nadir imagery.

FIG. 5 depicts a flow diagram of an example method 500 for recomputing targets according to example aspects of the present disclosure. One or more portion(s) of the method 500 may be implemented by a computing system that includes one or more computing devices such as, for example, the computing systems described with reference to the other figures(e.g., a satellite system 100, onboard computing system 103, computer vision system 104, flight computing system 107, etc.). Each respective portion of the method 500 may be performed by any (or any combination) of one or more computing devices. Moreover, one or more portion(s) of the method 500 may be implemented as an algorithm on the hardware components of the device(s) described herein.

At (505), the sensors 101, 102 of the satellite system 100 may capture sensor data 304 (e.g., input image 401). In some examples, the sensor data 304 may be captured by the forward-looking sensor 203 of the satellite. In some examples, the sensor data 304 may include a forward-looking image (FLI) of the geographic regions ahead of the satellite. The FLI may include sensor data 304 depicting geographic regions ahead of the satellite 200.

At (510), the cloud avoidance model 302 may perform cloud segmentation 402 to segment the input image 401. For instance, the cloud avoidance model 302 may segment the input image 401 based on objects (e.g., cloud-like objects) detected in the input image, imaging targets, etc. In some examples, the cloud avoidance model 302 may blur the image segments and label the blurred image segments to identify object characteristics (e.g., cloud characteristics). For instance, the cloud avoidance model 302 may label the blurred image segments as clouds and generate labels indicative of the level of cloud coverage within the blurred image segment.

The cloud avoidance model 302 may determine, based on comparing the level of cloud coverage for the respective image frame (e.g., imaging target) to a cloud threshold acquisition parameter, imaging targets which satisfy the cloud threshold acquisition parameter. In some examples, the cloud avoidance model 302 may output 307 data indicating the imaging targets which satisfy the cloud threshold acquisition parameter and transmit the output to the flight computing system 107.

At (515-520), the flight computing system 107 may receive the output 307 from the cloud avoidance model 302 and compute a trajectory of the satellite 200 which includes the imaging targets defined within the output 307. In some examples, the flight computing system 107 may implement the output 307 operations to flight controllers 301. For instance, the flight controllers 301 may determine an updated trajectory and generate output 308 to control a motion of the satellite system 100. In some examples, the output 308 may include one or more command instructions to control a motion of the satellite 200 based on the updated trajectory. In some examples, the command instructions may cause the satellite 200 to travel along the updated trajectory.

At (525), the flight controllers 301 may be unable to adjust the trajectory of the satellite 200 to travel along the updated trajectory. The trajectory may include the current orientation and direction of the satellite. In some examples, the slew trajectory 206 may be a subset of the trajectory of the satellite. For instance, the slew trajectory 206 may include a slew angle or position relative to the overall trajectory (e.g., orientation, direction, position, etc.) of the satellite as it travels along an orbit path 205. For instance, the probability of the satellite 200 passing over the imaging target indicated by the cloud avoidance model 302 may be low based on the current position of the satellite 200 orientation, orbital speed, slew position or angle, etc. In some examples, the flight controllers 301 may not have sufficient power or resources to execute the computed trajectory. For instance, thruster or reaction wheels may require additional power to align the satellite with the computed trajectory quickly enough to pass over determined imaging targets.

In some examples, the probability of imminently passing over may be calculated by the flight computing system 107. For instance, the flight computing system 107 may include different subsystems, software, and hardware for performing various flight control operations. In some examples, the probability of an imminent passing over may be calculated using orbital speed equations, acceleration equations, orbital period equations, etc. In some examples, the resulting calculations may produce probability of the satellite 200 passing over the imaging target. In some examples, a low probability of imminently passing over may be determined if the calculated probability is below 50%. In some examples, a low probability of imminently passing over may be determined if the calculated probability is below 70%. In some examples, any probability percentage may be considered a low probability. In other examples, a low probability of imminently passing over may be determined based on additional factors such as image acquisition parameters, priority of scheduled image acquisitions, or availability of other satellites to acquire the requested imagery.

By way of example, the flight computing system 107 may determine a low probability of imminently passing over by calculating a 60% chance of passing over the imaging target. In some examples, the flight computing system may transmit via the communications system 106 data indicating the low probability of imminent overpass to a ground station and a second satellite may be assigned to acquire the imagery which includes an 80% probability of imminent overpass.

At (530), the flight computing system 107 may determine a low probability of passing over the determined imaging targets and transmit data to the onboard computing system 103 to execute steps (510-520). In some examples, the flight computing system 107 may transmit data to the onboard computing system 103 to cause the forward-looking sensor 203 to capture additional sensor data 304. For instance, the satellite may be orbiting at thousands of miles per hour and an updated input image 401 may be needed to recompute the trajectory of the satellite.

At (535), the flight computing system 107 may determine a high probability of imminent overpass and generate one or more command instructions to control a motion of the satellite based on the updated trajectory. A high probability may include 70% or greater, 60% or greater, or any reasonable percentage. The satellite may pass over the determined imaging target and utilize one or more sensors 101, 102 to acquire imagery of the respective geographic region. In some examples, the satellite system 100 may downlink the acquired imagery to a ground station at a point during orbit where the communication system 106 may transmit the acquired imagery.

FIG. 6A depicts an example satellite maneuvering plan according to example aspects of the present disclosure. The example maneuvering plan includes an orbit track 600 which illustrates the location of a satellite (e.g., satellite system 100, satellite 200, etc.) as it orbits the Earth. In some examples, the orbit track 600 may indicate a complete path around the earth. In some examples, the orbit track 600 may prevent satellites from colliding. For instance, the orbit track 600 may indicate a unique path of travel for the satellite which allows for the coordination or orchestration of other satellites orbiting the Earth. For example, a plurality of satellites in a constellation may simultaneously orbit the Earth on various orbit tracks 600 which do not intersect or interfere with other satellite orbits. In other examples, the orbit track 600 may be shared by multiple satellites such that the satellites are in orbit positions spaced on the same on the orbit track 600 to avoid collisions.

Satellites having maneuvering capabilities may be capable of “slewing” as the satellite progresses along the orbit track 600. For example, while the satellite may maintain its position on the orbit track 600, it may slew left or right, relative to its direction of travel, such that geographic areas of Earth may be captured (i.e., by the payload sensor 204) which are not directly below the position of the satellite on the orbit track 600. While slewing allows a satellite to capture imagery which is not directly below its orbit track 600, greater amounts of slewing alter the perspective of the captured imagery and may be undesirable beyond a certain slew angle 206. Therefore, a predefined upper edge 601 and lower edge 603 may be established which represent the upper and lower boundaries within which potential imaging targets are located.

For example, a satellite may slew between an upper edge 601 and a lower edge 603, to capture images various imaging targets 604A-C between the upper edge 601 and the lower edge 603, creating an optimized slew track 602 as it orbits the Earth. For instance, the optimized slew track 602 may indicate an updated trajectory (e.g., output 308) based on output 307 generated by the cloud avoidance model 302 of the satellite system 100. In some examples, the optimized slew track 602 may include an optimized slew trajectory that passes over imaging targets 604A, 604B which do not include cloud coverage (e.g., avoiding clouds) or cloud coverage below the cloud coverage acquisition parameter. In some examples, the optimized slew track 602 may include the satellite’s orientation (e.g., angle, position, etc.) or movement in reference to its orbit track 600. As depicted in FIG. 6A, a satellite may navigate along the optimized slew track 602 above or below the orbit track.

In some examples, the optimized slew track 602 may be determined in consideration of cloud coverage at various imaging targets 604A-C. For instance, the optimized slew track 602 may avoid imaging target 604C based on its cloud coverage levels. For instance, imaging target 604C may be assigned to the satellite 200 traveling along the orbit track 600 as a result of the proximity of the imaging target 604C relative to the orbit track 600. In some examples, imaging target 604C may be assigned to the satellite traveling along the orbit track 600 as a result of the imaging target 604C being positioned within a field of view of the forward-looking sensors 203. For instance, the forward-looking sensor 203 may include a fish-eye field of view which encompasses the field of view of the payload sensor 204.

In some examples, the satellite may detect cloud coverage at the imaging target 604C which exceed the cloud coverage acquisition parameter, and avoid imaging target 604C based on detecting the presence of clouds. For instance, imaging target 604C may be associated with a 30% cloud coverage acquisition parameter and determine imaging target 604C is 70% obstructed by cloud coverage. Thus, the satellite may avoid imaging target 604C based on the cloud coverage above the cloud coverage acquisition parameter and instead update the optimized slew track 602 to acquire imagery of imaging target 604B instead.

For further illustration, after completing image acquisition of imagery target 604A, the current trajectory data (e.g., current trajectory data 306A) may indicate imagery target 604C as the next target scheduled for image acquisition. The cloud avoidance model (e.g. cloud avoidance model 302) may determine that imagery target 604C does not satisfy the cloud coverage acquisition parameter, and thus the optimized slew track 602 may be updated by the flight computing system (e.g. flight computing system 107) to slew the satellite to be positioned to capture imagery target 604B instead.

In some examples, the satellite may include a field of regard and may travel along the optimized slew track 602 within the field of regard. A field of regard may include the total area that a sensing system (e.g., forward-looking sensor 203) can perceive. In some examples, the field of regard may be based on the total area visible to the forward-looking sensor 203. In some examples, the field of regard may be greater than the FOV of the forward-looking sensor 203. For instance, the field of regard may be equal to or greater than the fish-eye field of view of the forward-looking sensor 203. In some examples, the field of regard may include off-nadir geographic regions visible by the payload sensor 204 in addition to the total area visible by the forward-looking sensor 203. For instance, the field of regard may include an upper edge 601 and a lower edge 603. In some examples, the forward-looking sensor 203 may capture sensor data 304 depicting geographic regions within the upper edge 601 and lower edge 603 of the field of regard. In some examples, the optimized slew track 602 may be positioned within the upper edge 601 and lower edge 603 of the field of regard due to the sensor data 304 captured by the forward-looking sensor 203 including input images 401 which include geographic regions within the upper edge 601 and lower edge 603. In some examples, the forward-looking sensor 203 may be moveable and cause the upper edge 601 and lower edge 603 of the field of regard to change as the forward-looking sensor 203 moves. As the satellite slews within the upper edge 601 and the lower edge, the payload sensor 204 may be positioned to include an off-nadir field of view greater than the fish-eye field of view of the forward-looking sensor 203.

FIG. 6B depicts a diagram of an example system 610 for controlling imaging satellites. For example, the system 610 can include a user device 605, a satellite command system 610, geostationary hub system(s) (“GEO hub(s)”) 615, geostationary satellite(s) 620, and a plurality of satellites 625 (e.g., a constellation of imaging satellites). The system 610 can also include one or more low-earth orbit (LEO) relay satellites 623. While the description and examples provided herein refer to one or more low-earth orbit relay satellites, the one or more relay satellites can also, or alternatively, include one or more medium-earth orbit (MEO) relay satellites, or geostationary satellites. The system 610 can include an order management (OM) system 660, a schedule system 665, a validation system 670, and/or a track scheduling system 675. The OM system 660 can recommend intermediate priority requests (e.g., a request that is given priority within the standard communication pathway 649A).

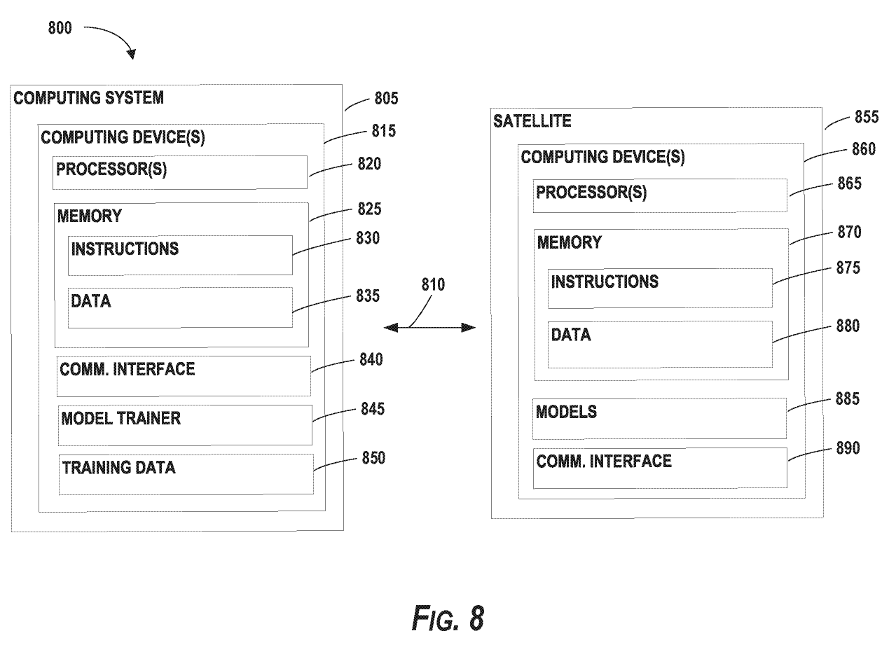

The imaging satellite(s) 625 can include a memory 626 (for storing an imaging task payload/image data, in some embodiments) and communications equipment 627, and configuration instructions for the operation thereof. In some embodiments, communications equipment 627 can include steerable antenna arrays and/or reprogrammable radio communications equipment which can be configured to communicate with the one or more LEO relay satellite(s) 623. In some examples, the configuration includes an instruction set for communicating via radio frequency communication. In some embodiments, the imaging satellite(s) 625 can include one or more computing devices, such as are described in FIG. 8. For instance, one or more computing devices of the satellite(s) 625 can execute instructions for the operation of imaging devices, communication devices, etc. In some embodiments, computing devices can include one or more image processors and/or image processing models. The one or more computing devices may include the onboard computing system 103, which may include the computer vision system 104 and/or the cloud avoidance model 302.

In some embodiments, rather than executing the cloud detection methods or cloud avoidance model 302 primarily onboard the satellite 625, the cloud detection can be performed on the forward-looking sensor data after the forward-looking sensor data is transmitted to a ground-based station (e.g., satellite command system 610). For example, the satellite 625 may continuously and/or periodically downlink raw and/or compressed sensor data captured by the forward-looking sensor 203 via the communication pathways 649A-C. A ground station, server array, and/or cloud-based computing architecture can then process the downlinked sensor data using the cloud detection or computer vision models as discussed herein. While this offboard configuration may introduce additional data transmission latency, the system may use the ground-based station for higher processing power to more rapidly and/or more accurately generate cloud maps and/or updated targets for instructions that can optionally and subsequently be uplinked back to one or more satellites 625.

These components can be configured to communicate via one or more networks 630. The user device(s) 605 can be associated with a user 635. The satellite command system 610 can be associated with an entity that provides image data services and/or controls one or more satellite(s) 625. The GEO hub(s) 615, geostationary satellite(s) 620, and/or the imaging satellites 625 can be associated with the entity and/or a different entity (e.g., that allows for the access/use of such assets).

The user device(s) 605 can be desktop computer, laptop computer, mobile device, server system, and/or other types of user devices. The user device(s) 605 can be configured to allow a user 635 to submit a request 640 for acquiring image data. For example, the user device(s) 605 can be configured to present one or more user interfaces 645 (e.g., via one or more display devices) that allow the user 635 to provide user input to request image data. Data indicative of the user interface(s) 645 can be provided by a computing system associated with the entity (e.g., the satellite command system 610, etc.) over the network(s) 630. The user interface(s) 645 can be presented via a software application, a website, browser, etc. The user 635 can provide user input (e.g., text input, voice input, touch input, selection input, etc.) via the user interface(s) 645 to select one or more parameters associated with the requested image data. For example, the user input can specify an imaging target (e.g., a location, geographic area, building, structure, etc.). The user input can specify the imaging target based on location information (e.g., coordinates, etc.), semantic name, identifier, and/or other information that identifies the target to be imaged. In some implementations, the user input can specify a time parameter (e.g., timeframe, point in time, etc.) at which the image data of the target is preferred to be acquired. In some implementations, the user input can specify a time parameter (e.g., timeframe, point in time, etc.) by which the image data of the target is preferred to be made available to the user 635 (e.g., delivered, available for download, viewing, etc.).

In some embodiments, a plurality of satellites 625 within the constellation are configured to continuously or semi-continuously transmit their respective cloud detections, localized cloud maps, and/or sensor data to a ground-based station. These can be used to generate a real-time cloud coverage database and/or global cloud map. The satellite command system 610 can use the cloud map to update instructions to one or more of the satellites 625 and/or update the user device 605 via the user interface 645. For example, in response to a user 635 submitting a request 640 specifying a target geographic area and/or a target time (e.g., “San Francisco + now”), the satellite command system 610 determines which satellite (e.g., a first satellite) is geographically closest to that location to capture the request. If the first satellite does not yet have the requested location within the field of view of its forward-looking sensors 203 (e.g., it is north of the target area), the user interface 645 can provide the user 635 with the real-time cloud data currently being captured by the first satellite’s forward-looking field of view, historical cloud data from a second satellite that previously passed over the target geographic area within a predetermined temporal threshold (e.g., twenty minutes prior), or a combination of both.

Additionally or alternatively, if historical or “stale” cloud data from a previous satellite pass is provided to the user and/or used to determine a schedule of a satellite, the system (via the satellite command system 610 and/or onboard one or more of the satellites 625) can determine, using the historical cloud data, a current statistical accuracy of the cloud data. Determining the current statistical accuracy of the cloud data can be based on meteorological metadata associated with the target geographic area (e.g., wind speed, wind direction, temperature, barometric pressure, humidity, historical cloud dissipation rates). For example, if the metadata indicates a low wind speed (e.g., 1 mph), the predictive model can determine a high probability that the cloud coverage layer remains substantially consistent since the last satellite pass.

The request 640 can be associated with a priority 650 for acquiring the image data. The priority 650 can be a standard priority by which it is sufficient for the image data to be acquired in a standard timeframe (e.g., over several hours). As further described herein, a standard priority can indicate that an associated image acquisition command can be placed in an imaging schedule/queue as it is received, without preferential treatment. In some implementations, the priority 650 can be an intermediate priority by which the image data is to be acquired and/or made available to the user 635 sooner than the standard timeframe. For example, as further described herein, the intermediate priority can indicate that an associated image acquisition command is to be given preferential treatment over the other pending requests (e.g., by moving the associated image acquisition command ahead of previously pending commands in a schedule/queue, by moving downlink and/or delivery time ahead in a schedule/queue, etc.). In some implementations, the priority can be a high priority, which can indicate that the requested image data is to be acquired and/or made available in a higher and/or the highest available rush manner. For example, as further described herein, a high priority can indicate that an associated image acquisition command is to be communicated to a satellite (e.g., via a particular communication pathway) in a manner that expedites image acquisition and delivery.

The priority 650 can influence the acquisition parameters used by the onboard cloud avoidance model 302. For example, the cloud threshold described above may be an acquisition parameter that can be modified by the priority level of the request. The priority 650 associated with the request for image data can be determined in a variety of manners. In some implementations, the user 635 can select the priority 650 associated with the request 640. For example, the user interface 645 may include one or more user interface element(s) (e.g., buttons, toggles, menus, lists, fields, etc.) that allow the user 635 to select the priority 650 (e.g., standard priority, intermediate priority, high priority, etc.) associated with the request 640. In some implementations, the ability to select such an element may be based at least in part on whether the entity can meet the request with the selected priority. For example, a computing system associated with the entity (e.g., the satellite command system 610) can determine whether one or more of the plurality of satellites 625 would be available to acquire image data of the requested target in the expedited manner associated with a high priority request (e.g., based on current/future satellite location, trajectory, memory resources, etc.). In the event that the entity can meet such a prioritized request (e.g., due to satellite availability), the user interface 645 can present a user interface element and/or other option for selecting a high priority. In the event that the entity cannot meet such a prioritized request (e.g., due to satellite unavailability), the user interface 645 may not present a user interface element and/or other option for selecting a high priority (e.g., greying-out element, omitting element from user interface, etc.).

In some implementations, the priority 650 associated with a request 640 can be determined based at least in part on a time parameter associated with the request. For example, the priority 650 of the request 640 can be determined based at least in part on a time by which the user 635 specifies that the image data is to be acquired and/or made available. By way of example, in the event that the user 635 specifies that the image data should be acquired and/or made available in less than one hour, the request 640 can be associated with a high priority. In another example, in the event that the user 635 does not specify that the image data should be acquired and/or made available within a certain timeframe, the request 640 can be associated with a standard priority. Such a determination can be made, for example, by the satellite command system 610 and/or another system.

In some implementations, the priority 650 can be determined based at least in part on the user 635 and/or type of user 635. For example, in the event that the user 635 is considered a higher value customer (e.g., due to a certain subscription, purchase history, contract, etc.), the priority 650 associated with a request can be determined to be a high priority. In another example, in the event that the user 635 is associated with a type of entity that generally needs/prefers expedited image data (e.g., an emergency response entity, etc.), the priority 650 associated with a request 640 can be determined to be a high priority. Such a determination can be made, for example, by the satellite command system 610 and/or another system. In some embodiments, the satellite 625 uses the forward-looking sensor 203 (i.e. as described above) to screen high-priority targets for clouds before they are within view of the payload sensor 204. The satellite 625 may move to capture off-nadir high-priority targets using one or more maneuvers, such as a slew maneuver.

In some implementations, the priority 650 can be determined based at least in part on the target (e.g., type of target, location, etc.). For example, in the event that the type of target may be subject to change at a higher rate (e.g., an area experiencing a wildfire), the priority 650 associated with a request can be determined to be a high priority. In another example, in the event that the type of target may be subject to change at a lower rate (e.g., a park undergoing a long-term reconstruction project), the priority 650 associated with a request 640 can be determined to be a high priority. In some implementations, the priority 650 may be based at least in part on the location of the target. For example, the target may include a movable and/or moving object (e.g., one or more automobiles). The target may be moving such that it will be subject to conditions that would make it more difficult to acquire image data of the target (e.g., the automobile(s) that are driving along a path that enters a tunnel). In such a case, the priority 650 associated with a request 640 can be determined to be a high priority (e.g., so that image data is acquired prior to the automobile(s) entering the tunnel). Such a determination can be made, for example, by the satellite command system 610 and/or another system.

In some embodiments, the priority 650 of a request 640 can adjust the threshold level of cloud coverage used by the onboard cloud avoidance model 302. For example, a “standard priority” request may be associated with a strict cloud threshold (e.g., 10%), causing the satellite to determine an updated trajectory to avoid the target if even light cloud cover is detected by the forward-looking sensor 203. Conversely, a “high priority” request (e.g., for wildfire monitoring) may be associated with a more lenient threshold and/or may trigger the cloud avoidance model 302 to prioritize sensors less impacted by clouds, such as a LWIR camera or SAR sensor, to ensure data acquisition despite environmental conditions.

The satellite command system 610 can be configured to obtain the request 640 for the image data from the user device(s) 605 (e.g., via the network(s) 630). The satellite command system 610 can parse the request (e.g., a data set, etc.) to determine the location of the target to be imaged and the time within which the image data is preferred to be acquired and/or made available to the user 635. As described herein, such timing can be determined based at least in part on a priority 650 and/or time parameters explicitly provided by the user 635.

The satellite command system 610 can be configured to determine an availability of the plurality of satellites 625 to acquire the image data based at least in part on the request 640. For example, the satellite command system 610 can obtain data associated with the satellites 625 (e.g., on a periodic basis, on-demand basis, on a scheduled basis, etc.) and determine whether any of the satellites 625 are available to acquire image data of the target within a timeframe that is sufficient for the request 640 (e.g., given the associated priority 650). The data associated with the satellites 625 can be indicative of various parameters associated with the satellites 625. For instance, the data associated with the satellites 625 can include a schedule indicative of the pending image acquisition commands/sequences of a given satellite or group of satellites. Additionally, or alternatively, the data associated with the satellites 625 can include data indicative of the past, present, and/or future trajectory of the satellite(s). Additionally, or alternatively, the data associated with the satellites can include information associated with the power resources (e.g., power level, etc.), memory resources (e.g., storage availability, etc.), communication resources (e.g., bandwidth), etc. of the satellite(s). Additionally, or alternatively, the data associated with the satellites 625 can include health and maintenance information associated with the satellite(s) 625 (e.g., maintenance schedules, damage reports, other status reports, etc.). Additionally, or alternatively, the data associated with the satellites 625 can include data indicative of the type and/or status of the hardware (e.g., antenna, communication interfaces, etc.) and/or software onboard a satellite.

The satellite command system 610 can be configured to determine whether at least one satellite is available to acquire image data in accordance with the request 640 based at least in part on the data associated with the satellites 625. For example, the satellite command system 610 can determine whether a satellite 625 (e.g., with sufficient power, memory, communication resources, etc.) is on a trajectory or can be moved to a trajectory/position that would allow the satellite 625 to acquire image data of a target (e.g., an area experiencing a wildfire) within a timeframe that meets the request 640 (e.g., within a timeframe associated with a high priority request). If so, the satellite command system can determine that a satellite from the plurality of satellites 625 is available to acquire the requested image data and can accept the request. Additionally, or alternatively, the satellite command system 610 can determine availability based on the currently scheduled imaging tasks of the satellites and whether such a task can be disturbed. In some implementations, the satellite command system 610 can provide a confirmation message to the user 635 (e.g., via the user interface 645).

The satellite command system 610 can be configured to select a satellite from the plurality of satellites (e.g., a plurality of imaging satellites) to acquire the image data based at least in part on the availability of the satellites 625 to acquire the image data. For example, in the event that only one satellite is available, the satellite command system 610 can select that available satellite to acquire the image data of the target. In some implementations, the satellite command system 610 can select a satellite from among a plurality of satellites that are available to acquire the image data. For example, the satellite command system 610 can perform an optimization analysis to determine which of the satellites 625 can be chosen to acquire the requested data in an expedited manner while minimizing the impact (e.g., time delay) on the other pending tasks and/or the satellite itself (e.g., power/memory resources).

The satellite command system 610 can be configured to generate an image acquisition command 655 for instructing an imaging satellite 625 to acquire image data. The image acquisition command 655 can include parameters for an imaging satellite 625 to utilize in order to acquire the requested image data. For example, the image acquisition command 655 can include data indicative of a location of the target, the order in which the associated data is to be acquired relative to other imaging tasks, a position/orientation of the imaging satellite 625, sensor settings (e.g., camera settings, etc.), and/or other information. In some implementations, as further described herein, an image acquisition command 655 can include a plurality of image acquisition tracks that indicate the sequences in which an imaging satellite 625 is to acquire image data.

In some embodiments, image acquisition commands 655 can comprise instructions to capture one or more images of one or more subjects of interest (SOIs). In some embodiments, an SOI can be an area of interest (AOI), such as, for example, a geographical area of which images are desired. For instance, an image acquisition command 655 can specify one or more coordinates for capturing images depicting a location and/or an area.

Additionally, or alternatively, image acquisition commands 655 can comprise instructions to determine one or more AOIs based on an indicated SOI. For instance, an SOI may have known or unknown whereabouts. An SOI can include any object; any structure; any entity; any land, air, or water-borne vehicle; any animal or groups of animals (e.g., present on land, air, and/or water); any weather formation or other natural, visually identifiable subject; or substantially any other subject of which images are desired. In some embodiments, the SOI can be specified in categorical terms and/or specific terms. For instance, an image acquisition command 655 can comprise instructions to obtain images of a specific SOI (e.g., a particular SOI having a specific identity, such as a particular ship in the ocean, particular weather formation being tracked, etc.). In some embodiments, an image acquisition command 655 can additionally or alternatively comprise instructions to obtain images of a category of SOIs, such that the instructions indicate for the imaging satellite(s) 625 to obtain image data of any subjects that match a particular profile and/or description. In this manner, an image acquisition command 655 can correspond to an SOI, and, in some embodiments, an AOI can be determined based on recognition of the SOI within an area.

The satellite command system 610 can be configured to transmit image acquisition commands to the selected imaging satellite via a plurality of communication pathways. The plurality of communication pathways can include a number of uplink communication pathways 649A-649C. For instance, the plurality of uplink communication pathways 649A-C can include a first uplink communication pathway 649A. The first uplink communication pathway 649A can include an uplink communication pathway via which an image acquisition command 655 is sent directly to the satellite 625. For instance, a signal can be sent from a ground-based command center to a satellite 625 when the orbital access and pointing/range requirements of that pathway are met (e.g., when the satellite is in an orbit position to receive a transmission from a ground-based command center). The first uplink communication pathway 649A may allow for larger sizes of data to be transmitted to a satellite 625. Due to the orbital access and pointing requirements, the first uplink communication pathway 649A may also have latency drawbacks for uplink (and/or downlink, when used for downlink in some embodiments). Thus, the first uplink communication pathway 649A may not always provide a ubiquitous, near-real time communication mechanism for transmitting data to and/or from the satellite(s) 625. The first uplink communication pathway 649A may also be referred to as the “standard uplink communication pathway 649A.”

The plurality of uplink communication pathways 649A-C can include a second uplink communication pathway 649B. The second uplink communication pathway 649B can include an uplink communication pathway via which an image acquisition command is indirectly communicated to the satellite via a GEO hub 615 and/or a geostationary satellite 620. The GEO hub(s) 615 can be ground stations operated by the entities associated with the geostationary satellites 620. The geostationary satellites 620 can be satellites that travel at an orbit above the surface of the earth (or other body) and that generally provide line-of-sight coverage of a third of the Earth (or other body). For example, a single geostationary satellite 625 can be on a line of sight with about 40 percent of the earth’s surface. Three such satellites, each separated by 120 degrees of longitude, can generally provide coverage of the entire Earth. This can allow the second uplink communication pathway 649B to provide a near-real time, persistent and ubiquitous communication solution for the satellite command system 610 to communicate with the satellites 625. The second uplink communication pathway 649B may also be referred to as the “RT communication pathway.” Although communication pathways 649A-649B have heretofore been referred to as “uplink” communication pathways, it is to be understood that communication pathways 649A-649B can be used for uplink and/or downlink, such as shown in FIG. 6B.

A third communication pathway which can be used for uplink and/or downlink is shown as downlink communication pathway 649C. The satellite command system 610 can transmit and/or receive communications (e.g., via first or third party ground-based stations) with the LEO relay(s) 623. The LEO relays 623, in turn, may communicate with the imaging satellite(s) 625 for the transmission and/or receipt of imaging task payloads (e.g., including image data, image acquisition commands, tip-and-cue instruction sets, etc.). In some embodiments, the uplink/downlink communication pathway 649C can include multiple transmissions between two or more imaging satellite(s) and one or more LEO relay(s) 623, for relaying imaging task payloads between imaging satellite(s) and/or to ground-based stations.

In some embodiments, the uplink/downlink communication pathway 649C can include communications directly with the user device 605. For instance, the user device 605 can include a terminal provided to the user 635 by an entity associated with the LEO relays 623, which can be the same entity as associated with the satellite command system 610 and/or the imaging satellite(s) 625 or can be a different entity than that associated with the satellite command system 610 and/or the imaging satellite(s) 625. Additionally, or alternatively, the user device 605 can be a device associated with an end-user, requestor, and/or consumer of the transmitted data.

The uplink/downlink communication pathway 649C can be used to facilitate a real-time “tip-and-cue” workflow triggered by the onboard detection of clouds. If a first imaging satellite 625B determines (e.g., via the forward-looking sensor 203) that a high-priority imaging target is obscured by clouds beyond a threshold, it can transmit an imaging task payload via the LEO relay 623 to a second imaging satellite 625A. This payload can include instructions for the second satellite to adjust its slew trajectory to capture the target from a different angle or to utilize a different spectral band. This process can use the low-latency relay network to help ensure high-priority requests are satisfied even when the primary satellite’s view is obstructed.

By way of example, the destination of the imaging task payload can be a ground-based station. An imaging satellite 625 (e.g., selected by the satellite command system 610) may capture requested image data and store the image in an imaging task payload. The imaging task payload can include one or more frames of a video recording (e.g., captured via the imaging satellite 625). The imaging task payload may be transmitted to one or more LEO relays 623. In some embodiments, the LEO relay(s) 623 may transmit the imaging task payload to a ground-based station for servicing the request 640 (e.g., processing, storing, providing to an end-user, providing to another system/entity, etc.). The LEO relay(s) 623 may transmit the imaging task payload to one or more other relay satellites (e.g., one, two, three, or more other relay satellites; optionally also in low-earth orbit), and one of the other relay satellite(s) may transmit the imaging task payload to the ground-based station. In this manner, multiple relay satellites (e.g., two, three, or more) may be used to relay the imaging task payload to a destination for servicing the request 640. This may allow the one or more LEO relay(s) 623 to relay the imaging task payload to the ground-based station in a manner quicker than would be provided by waiting for the selected imaging satellite to arrive in the appropriate position in its orbit to directly downlink to the ground-based station. In some embodiments, the communication pathway 649C including one or more LEO relay(s) 623 can be selected based at least in part on a determination that a request is associated with a higher priority 650 (e.g., higher than a threshold), as similarly described herein.

In some examples, the imaging task payload may include information and/or instructions corresponding to additional image acquisition command(s), and the destination(s) of the imaging task payload may include one or more additional imaging satellites 625. For example, one or more additional imaging satellites 625 may include an imaging task payload receiver. For instance, a first imaging satellite 625 may be selected for acquiring the image data, and the first imaging satellite 625 may acquire and/or attempt to acquire image data. The first imaging satellite 625 can be instructed to transmit additional and/or further image acquisition command(s) to a second imaging satellite 625. The first imaging satellite 625 can transmit an imaging task payload containing the additional and/or further image acquisition command(s) (optionally also containing image data from the first imaging satellite) to one or more LEO relays 623 as described herein. The one or more LEO relays 623 may relay the imaging task payload to a second imaging satellite 625 for further acquisition of image data (e.g., of the same or different SOI). Optionally, if the first imaging satellite 625 successfully collected image data, the portion of the imaging task payload containing the successfully collected image data can be transmitted to a ground-based station or ground-based terminal in the manner described herein. In some embodiments, multiple imaging satellites 625 can acquire image data and successively forward the imaging task payload (e.g., optionally including the acquired image data) to maintain real-time or at least near real-time monitoring of a SOI, such as for real-time or at least near real-time monitoring of an AOI.

In one embodiment, at least near real-time monitoring can include the capture of one or more images in quick succession. For instance, in some embodiments, the images can be captured in quick succession in such a manner that the images can be combined and/or viewed as frames of a video. Advantageously, the low latency associated with example embodiments of communications pathways of the present disclosure can provide for the delivery of a plurality of one or more frames of a video in a near real-time fashion (e.g., “streaming” the captured successive images to a ground-based station). In some embodiments, a plurality of imaging satellites can cooperatively stream video imagery (e.g., successively captured images of a subject) by relaying the imaging task payload via one or more LEO relays 623, as described herein. For instance, a first imaging satellite 625 can continuously monitor an SOI (e.g., capture image data, such as for frames of a video depicting the SOI) while the SOI remains within view of the first imaging satellite 625, and the first imaging satellite 625 can then relay the imaging task payload to a second imaging satellite 625 for further acquisition of image data. Additionally, in some embodiments, the first and second imaging satellites 625 can continuously relay captured image data via the LEO relays 623 to a destination (e.g., ground-based terminal) while monitoring the SOI. For instance, the first and second imaging satellites 625 can include a steerable antenna array trained on at least one of the LEO relays 623 while monitoring the SOI.

The one or more LEO relays 623 of the communication pathway 649C can communicate with the imaging satellite(s) in a continuous manner, in a batch/burst manner, and/or in another manner. For example, in some embodiments, the imaging satellite(s) 625 can always be tracked via at least one of the LEO relays 623 (e.g., with a steerable antenna array) to constantly maintain for a period of time a communication pathway in readiness for transmissions from the imaging satellite 625. In some embodiments, the imaging satellite 625 and at least one of the LEO relay(s) 623 can communicate on a schedule, such as based on times which correspond to scheduled and/or predicted relative positions/orientations of the respective satellites. In some embodiments, the LEO relay(s) 623, the imaging satellite(s) 625, and/or the ground-based station(s) can communicate using radio frequency communications and/or optical transmissions (e.g., for downlink and/or uplink). For instance, one or more of the radio frequency communications and/or one or more of the optical transmissions can comprise signals of any suitable frequency. In some examples, one or more signals can be of a frequency of from about 5 GHz to about 20 GHz. In some examples, one or more signals can be of a frequency of about 20 GHz to about 40 GHz. In some examples, one or more signals can be of a frequency of about 26.5 GHz to about 40 GHz, such as a frequency of about 26.5 GHz to about 30 GHz.

FIG. 6C provides a diagram overview of the RT communication pathway 649B and the uplink/downlink communication pathway 649C. For example, the RT communication pathway 649B can include a GEO communication infrastructure. One example GEO communication infrastructure that can be used to provide a near real-time communication solution is Very Small Aperture Terminal (VSAT). This can include a two-way satellite communication system. For instance, the RT communication pathway 649B can include a plurality of geostationary satellites 620 with architecture for providing global beams such as, for example, bent-pipe C-band transponders providing global coverage beams. For example, as shown, three geostationary satellites 620 (e.g., with global C-band beams) placed 120 degrees apart can provide global coverage (e.g., at a 500 km low earth orbit altitude). The bent-pipe architecture can mirror the uplink channel to a lower frequency downlink channel (e.g., 6 GHz to 4 GHz). C-band transponders can be, for example, 36 MHz wide, while a maximum global covered latitude can be ±81° for terrestrial stations and ±90° for 500 km to 700 km low earth orbit. Such an approach can provide global low earth orbit coverage, a deterministic latency (e.g., ~10 s), lower cost, and a flexible bent-pipe architecture that allows for full control of modulation, coding, and encryption. The infrastructure of the RT communication pathway 649B (e.g., the GEO hub(s) 615, geostationary satellite(s) 620, etc.) can be associated with one or more other entities (e.g., third party vendors) that are different than the entity associated with the satellite command system 610 (e.g., the imaging service provider). In addition to C-band global beams, regional and spot beams are available at C, Ku, or Ka band that provide effective isotropic radiated power (EIRP) and gain over noise temperature (G/T). By leasing regional beams on multiple GEO satellites (more than 3) global coverage could be achieved at higher data rates.

To establish a network connection for the RT communication pathway 649B, the satellite command system 610 can utilize dedicated bandwidth from the geostationary satellites 620 and GEO hub(s) 615. A link can be established to a particular satellite 625B, for example (e.g., a LEO satellite, MEO satellite, etc.), by selecting the corresponding geostationary satellite 620 and GEO hub 615. As described herein, the GEO hub(s) 615 can be ground stations with communication infrastructure for communication with the geostationary satellites 620. In some implementations, modems tuned to dedicated frequencies for the entity associated with the satellite command system 610 can be housed at the GEO hub(s) 615. The RT communication pathway 649B can achieve, for example, a round trip time of 0.5 seconds up to several seconds to transmit an image acquisition command 655 to a satellite 625B.

The RT communication pathway 649B may not require special pointing constraints for enforcing tasking operations (e.g., transmitting image acquisition commands). To allow for on-demand, persistent, near real-time tasking, a receiver on the satellite 625B may be kept on. In some implementations, tasking reaction time can be on the order of minutes depending on the image acquisition command length (e.g., a deterministic quantity). Tasking can be done in an open loop fashion. Tasking data rates can be, for example, on the order of 10 s of bits per second (bps) without pointing and could go up to 500 bps with pointing (if desired).

The satellite 625A, 625B may optionally not communicate (e.g., to the satellite command system 610) an acknowledge message of the receipt of the image acquisition command 655. This can help to avoid the consistent powering and positioning (e.g., toward a geostationary satellite 620) of a satellite transmitter. In some implementations, to establish a reverse link for an acknowledgement (if desired), a satellite 625A can turn the transmitter on and point it towards a geostationary satellite(s) 620 to follow the same/similar pathway to the satellite command system 610 as the image acquisition command 655.

Image acquisition commands 655 sent from the satellite command system 610 can be transmitted via the network(s) 630 (e.g., an internet network, etc.) to a GEO hub 615. The GEO hub 615 can transform an image acquisition command 655 to a radio signal. The GEO hub 615 can provide frequency translation, amplification, and retransmission to the geostationary satellite 620.

The RT communication pathway 649B can allow the system 610 to overcome certain communication-related issues. For example, to mitigate potential Doppler problems, the system 610 can utilize a bandwidth expansion technique such as, for example, direct sequence spread spectrum (DSSS) scheme. Bandwidth expansion can ease carrier synchronization and tracking, ease reference frequency oscillator tolerances, allow the increase of total transmitted power without violating maximum power spectral densities (PSD), etc. Moreover, DSSS technique can allow for the use of the same shared spectrum to communicate with a fleet of satellites 625A, 625B (e.g., LEO satellites). In another example, uplink transmissions (e.g., at 6 GHz) can be subject to an angular emission mask to avoid interference to adjacent geostationary satellites. In some implementations, assets in the RT communication pathway 649B can use a small aperture low gain antenna that could illuminate multiple geostationary satellites. To mitigate this problem, one example solution can be to operate with a low power transmitter (1 W) occupying a particular bandwidth (e.g., 1 MHz bandwidth).

As shown, in the RT communication pathway 649B, the satellite command system 610 can communicate an image acquisition command 655 to a GEO hub 615. As further described herein, the GEO hub 615 can communicate the image acquisition command 655 (e.g., a radio signal translation thereof) to a geostationary satellite 620. The geostationary satellite 620 can communicate the image acquisition command 655 to the selected satellite 625A, 625B that is to acquire the requested image data. In some implementations, a GEO hub 615 can communicate the image acquisition command 655 to one or more other GEO hubs 615. This can allow the GEO hub(s) 615 to communicate the image acquisition command 655 to the geostationary satellite 620 that can most effectively transmit the image acquisition command 655 to the selected satellite 625A, 625B. For example, a geostationary satellite 620 that is associated with a selected satellite 625A, 625B (e.g., with the selected satellite in the coverage area, within LOS of the selected satellite 625A, 625B, etc.) may be the most effective intermediary for communicating with that selected satellite 625A, 625B.

As also shown in FIG. 6C, relay satellite(s) 623 can be used to relay communications between one or more imaging satellites 625 (e.g., imaging satellites 625A and 625B) and also between the imaging satellite(s) 625A, 625B and a ground-based station 611. For instance, the imaging satellite(s) 625A, 625B may be out of range of or otherwise inaccessible by the ground-based station 611, but by relaying an imaging task payload via the relay(s) 623, the payload can be delivered to the ground-based station 611 with low latency. In another example, the imaging satellite 625B may be commanded to acquire image data of a particular AOI and/or SOI (e.g., with an image acquisition command sent via the RT communications pathway 649B). The imaging satellite 625B may succeed, or it may fail to obtain satisfactory results. Depending on the command, the imaging satellite 625B may, in some embodiments, forward the image acquisition command to imaging satellite 625A via the LEO relay 623 for further image capture of the AOI and/or SOI (e.g., to obtain at least one successful image capture and/or additional successful image captures).

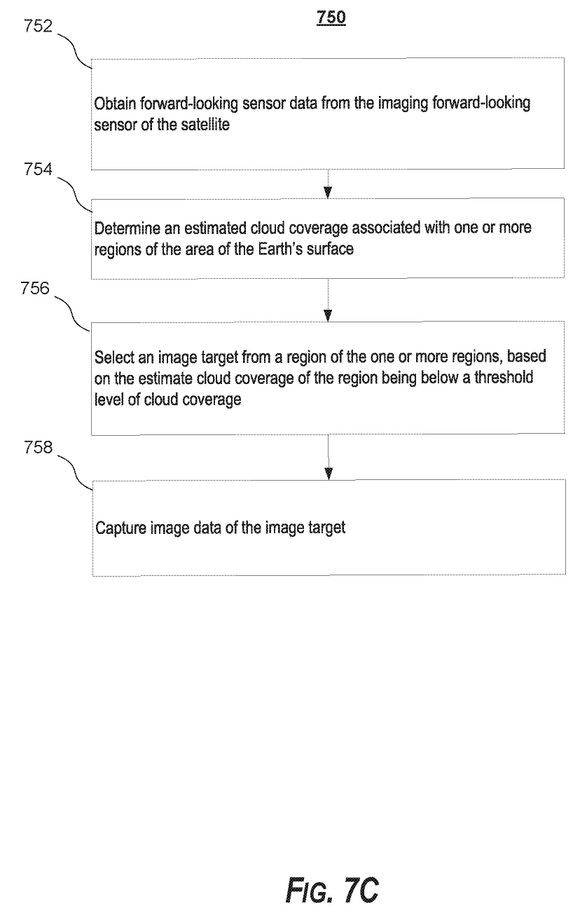

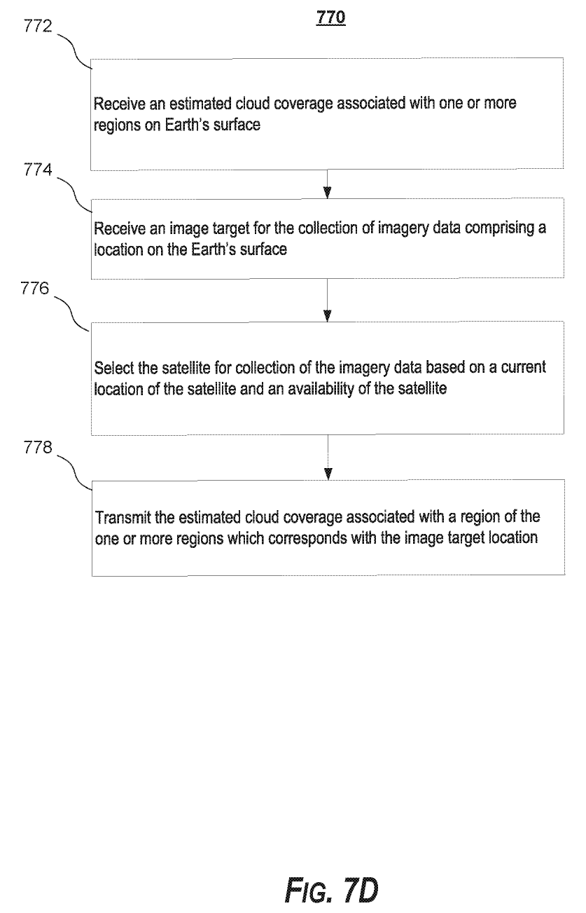

FIG. 7A depicts a flow diagram of an example method 700 according to example embodiments of the present disclosure. One or more portion(s) of the method 700 may be implemented by a computing system that includes one or more computing devices such as, for example, the computing systems described with reference to FIGS. 1-6C. Each respective portion of the method 700 may be performed by any (or any combination) of one or more computing devices. Moreover, one or more portion(s) of the method 700 may be implemented as an algorithm on the hardware components of the device(s) described herein, for example, to control satellites to avoid clouds. FIG. 7A depicts elements performed in a particular order for purposes of illustration and discussion. Those of ordinary skill in the art, using the disclosures provided herein, will understand that the elements of any of the methods discussed herein may be adapted, rearranged, expanded, omitted, combined, and/or modified in various ways without deviating from the scope of the present disclosure. FIG. 7A is described with reference to elements/terms described with respect to other systems and figures for example illustrated purposes and is not meant to be limiting. One or more portions of method 700 may be performed additionally, or alternatively, by other systems.

At (702), the method 700 may include receiving a command to capture image data of an imaging target. As described herein, the command may be an image acquisition command received from a ground-based command center or a control center. The command may specify a geographic region, a specific location, or a subject of interest to be imaged. In some examples, the command may be sent directly to the satellite system 100 via a communication system 106 when pointing and range requirements are met. The command may further indicate acquisition parameters, such as a threshold level of tolerance for cloud coverage.

At (704), the method 700 may include obtaining forward-looking sensor data from the imaging forward-looking sensor of the satellite. As described herein, the sensor data may be captured by a forward-looking sensor affixed to the satellite in a forward-oriented position. The forward-looking sensor may comprise a visible imaging system (VIS) camera, a longwave infrared (LWIR) camera, or other types of sensors. In some examples, the forward-looking sensor 203 is positioned at a look-ahead angle relative to nadir, such as +25 degrees. This orientation can allow the satellite to receive data ahead of its potential path of travel. This forward-looking sensor data may be used as input for a cloud avoidance model.

At (706), the method 700 may include determining, based on the image forward-looking sensor data, a cloud coverage associated with the imaging target. For instance, a cloud avoidance model may process the sensor data to identify the presence and percentage of clouds within a geographic area corresponding to the imaging target. In some implementations, the model is a convolutional neural network (CNN) trained to detect and segment objects. The model may perform cloud segmentation techniques to isolate clouds from other features like snow or ice. In some embodiments, the system may use metadata to improve confidence levels. The level of cloud coverage may be determined by calculating the percentage of pixels associated with detected clouds relative to an image segment.

At (708), the method 700 may include comparing the cloud coverage associated with the imaging target to a threshold level of cloud coverage. For instance, the cloud avoidance model 302 may determine if the detected cloud coverage exceeds or is within a tolerance level specified in the image acquisition request. A threshold level may be represented as a percentage, an integer value, or an upper limit. In some examples, comparing the cloud coverage includes determining that the cloud coverage is within the threshold, indicating that the imaging target is sufficiently clear for acquisition. In other examples, the comparison includes determining that the cloud coverage exceeds the threshold, which indicates the target may be obstructed.

At (710), the method 700 may include transmitting, based on comparing the cloud coverage associated with the imaging target to a threshold level of cloud coverage, an indication of a success metric or an indication of a failure metric associated with the image forward-looking sensor data. If the cloud coverage is within the threshold, the satellite may transmit a success metric, which may include an indication that the target is clear or the forward-looking sensor data itself. Conversely, if the cloud coverage exceeds the threshold, the satellite may transmit a failure metric, such as an indication of excessive obstruction. These indications may be transmitted to a ground station via a downlink communication pathway. In some embodiments, the transmission occurs via a communication pathway comprising one or more relay satellites to ensure near-real-time delivery.

According to further aspects of the present disclosure, in response to a success metric, the satellite may determine a probability of passing over the imaging target based on its current trajectory. If the probability is high, the satellite may capture image data of the imaging target using a payload imaging sensor and transmit the resulting imagery to a ground station. Alternatively, in response to a failure metric, the satellite system may determine an updated imaging target. Based on comparing the cloud coverage of this updated target to a threshold, the system may then determine an updated trajectory (e.g., a slew trajectory) for the satellite to acquire imagery from a less-obstructed location.

FIG. 7B depicts a flow diagram of an example method 730 for determining cloud coverage and transmitting metrics according to example embodiments of the present disclosure. One or more portions of the method 730 may be implemented by a computing system including one or more computing devices, such as the onboard computing system 103 or computer vision system 104.

At (732), the method 730 may include obtaining forward-looking sensor data from the imaging forward-looking sensor of the satellite. As described herein, the forward-looking sensor 203 may be positioned at a look-ahead angle relative to nadir, such as +25 degrees, to capture image data of geographic regions ahead of the satellite's current trajectory. The image data may be captured using various sensor types, including VIS and/or LWIR cameras.

At (734), the method 730 may include analyzing an image frame of the image forward-looking sensor data. For instance, the cloud avoidance model 302 may process the image frame to identify spectral bands (e.g., 1.36-1.38 μm) corresponding to clouds. In some implementations, the analysis includes fusing the sensor data with metadata (e.g., sensor temperature, sun angle, or slew angle) to compensate for environmental factors and improve identification accuracy.

At (736), the method 730 may include generating a plurality of image segments, wherein the plurality of image segments is associated with one or more clouds depicted in the image frame. The model may perform cloud segmentation techniques to isolate detected clouds or to segment the image based on specific imaging targets. This segmentation allows the system to encapsulate respective clouds or geographic regions within bounding shapes for further processing.

At (738), the method 730 may include generating a plurality of blurred image segments, wherein the plurality of blurred image segments are indicative of cloud characteristics. For instance, the cloud avoidance model may project a box blur onto the image segments, which may include a spatial domain linear filter such as a Gaussian blur. Blurring the image segments can reduce the number of features the model processes.

At (740), the method 730 may include determining the cloud coverage associated with respective blurred image segments of the plurality of blurred image segments. The model may analyze the blurred segments to generate labels indicative of the percentage of pixels associated with clouds relative to the bounding shape. This determination may also use metadata, such as Earth surface angle, to assess whether detected clouds are dense enough to obscure the imaging target.

At (742), the method 730 may include transmitting an indication of a success metric or an indication of a failure metric associated with the image forward-looking sensor data. This transmission is based on a comparison between the determined cloud coverage and a threshold level (e.g., 30%), which may be adjusted based on the priority of the request. In some examples, the metric is transmitted via the RT communication pathway and/or via one or more LEO relay satellites to ensure near-real-time delivery to a ground station or another satellite. A success metric may trigger the capture of imagery using the payload sensor, while a failure metric may an image acquisition command to be forwarded to a second satellite via the relay network to capture the target from a different angle and/or spectral band.

FIG. 7C depicts a flow diagram of an example method 750 for autonomous target selection and image acquisition according to example embodiments of the present disclosure. In some implementations, method 750 provides a mechanism for a satellite to make automatic decisions on how to slew to capture regions within a wide field of view when the satellite has no scheduled tasks for the upcoming field of view. One or more portions of the method 750 may be implemented by the onboard computing system 103, the computer vision system 104, and/or the flight computing system 107.

At (752), the method 750 includes obtaining forward-looking sensor data from the imaging forward-looking sensor of the satellite. The forward-looking sensor data is associated with a forward-looking field of view that includes an area of the Earth’s surface corresponding with a future field of view of an imagery sensor (e.g., payload sensor 204) of the satellite. In some embodiments, the forward-looking sensor comprises a fish-eye field of view of 120 degrees or greater, allowing it to capture imagery within the full future field of regard of the payload sensor when positioned off-nadir.

At (754), the method 750 includes determining an estimated cloud coverage associated with one or more regions of the area of the Earth’s surface based on the forward-looking sensor data. For instance, the cloud avoidance model may analyze the sensor data to identify the percentage of pixels associated with detected clouds relative to one or more geographic regions. This determination may be enhanced by fusing the sensor data with metadata to improve the confidence level of the cloud estimation.

At (756), the method 750 includes selecting an image target from a region of the one or more regions within the future field of view. This selection is based at least in part on the estimated cloud coverage of the region being below a threshold level of cloud coverage (e.g., 10% or 30%). In some implementations, where the area of the Earth's surface includes a plurality of regions, selecting the image target comprises ranking the plurality of regions based on a combination of the estimated cloud coverage and at least one secondary priority metric.

According to further aspects of the selection process, secondary priority metrics may include a duration of time elapsed since a prior image of the region was captured, a historical interest metric associated with the region (e.g., based on client value or strategic prioritization), or a historical frequency of cloud-coverage-related imaging failures associated with the region. In response to selecting the image target, the method may include generating a command to modify an orientation of the satellite to align a field of view of the imagery sensor with the image target. This command may include a slew command or slew trajectory to tilt the satellite left or right relative to the orbit path. The flight computing system may implement these translated controls to adjust the satellite's position to an off-nadir position suitable for capturing the selected target.

At (758), the method 750 includes capturing image data of the image target using the imagery sensor (e.g., payload sensor 204). The captured imagery may then be stored in the storage system or transmitted to a ground-based station via the communication system using one or more communication pathways, such as the RT communication pathway and/or via LEO relay satellites.

FIG. 7D illustrates an example method 770 for tasking a collection of imagery data between a satellite and ground-based systems. At (772), the system receives an estimated cloud coverage associated with one or more regions on the Earth’s surface. This estimation is derived from forward-looking sensor data obtained by a satellite’s forward-looking sensor. The forward-looking sensor can have a field of view that corresponds with and/or includes a future field of view of the satellite's primary imagery sensor. Based on this data, the system determines the cloud characteristics and transmits the resulting estimates to a ground-based station.

At (774), the method involves receiving an image target for the collection of imagery data, which defines a specific location on the Earth’s surface. This image target is typically provided by a remote computing device and includes detailed location data, such as coordinates or semantic identifiers. In response to receiving the target, the system at (776) selects the satellite for the collection task based on a comprehensive evaluation of its current location and availability. This selection process may be based on the satellite’s trajectory direction, power levels, and/or memory resources to ensure the mission is feasible given the requested location data.

At (778), the method transmits the estimated cloud coverage associated with the specific region corresponding to the image target location back to the remote computing device. This step helps ensure that the tasking command is informed by the most recent environmental assessments.

FIG. 8 depicts an example computing system 800 that may be used to implement the methods and systems according to example aspects of the present disclosure. The system 800 may include computing system 805 (e.g., ground station) and satellite 855 (e.g., satellite system 100), which may communicate with one another using transmission signals 810 (e.g., radio frequency transmissions). The system 800 may be implemented using a client-server architecture and/or other suitable architectures.

The computing system 805 may include one or more computing device(s) 815. Computing device(s) 815 may include one or more processor(s) 820 and one or more memory device(s) 825. Computing device(s) 815 may also include a communication interface 840 used to communicate with satellite 855 and/or another computing system/device. Communication interface 840 may include any suitable components for communicating with satellite 855 and/or another system/device, including for example, transmitters, receivers, ports, controllers, antennas, or other suitable components.

Processor(s) 820 may include any suitable processing device, such as a microprocessor, microcontroller, integrated circuit, logic device, or other suitable processing device. Memory device(s) 825 may include one or more computer-readable media, including, but not limited to, non-transitory computer-readable media, RAM, ROM, hard drives, flash drives, or other memory devices. Memory device(s) 825 may store information accessible by processor(s) 820, including computer-readable instructions 830 that may be executed by processor(s) 820. Instructions 830 may be any set of instructions that when executed by processor(s) 820, cause one or more processor(s) 820 to perform operations. For instance, execution of instructions 830 may cause processor(s) 820 to perform any of the operations and/or functions for which computing device(s) 815 and/or computing system 805 are configured (e.g., such as the functions of a satellite ground station, GEO hub, etc.). In some implementations, execution of instructions 830 may cause processor(s) 820 to perform, at least a portion of, methods 700 according to example embodiments of the present disclosure.

As shown in FIG. 8, memory device(s) 825 may also store data 835 that may be retrieved, manipulated, created, or stored by processor(s) 820. Data 835 may include, for instance, any other data and/or information described herein. Data 835 may be stored in one or more database(s). The one or more database(s) may be connected to computing device(s) 815 by a high bandwidth LAN or WAN, or may also be connected to computing device(s) 815 through various other suitable networks. The one or more databases may be split up so that they are located in multiple locales.

The computing system 805 may include a model trainer 845 that trains the machine-learned models 885 stored at the satellite 855 using various training or learning techniques. For example, the machine-learned models 885 may be trained using a loss function. By way of example, for training a cloud avoidance model, the model trainer 845 may use a loss function. For example, a loss function may be backpropagated through the machine-learned models 885 to update one or more parameters of the machine-learned models 885 (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

The model trainer 845 may train the machine-learned models 885 (e.g., cloud avoidance model) in an unsupervised fashion. As such, the machine-learned models 885 may be effectively trained using unlabeled data for particular applications or problem domains, which improves performance and adaptability of the machine-learned models 885.

The computing system 805 may modify parameters of the machine-learned models 885 (e.g., the cloud avoidance model 302) based on the loss function such that the machine-learned models 885 may be effectively trained for specific applications in an unsupervised manner without labeled data.

The model trainer 845 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 845 may perform a number of generalization techniques (e.g., weight decays, dropouts, etc.) to improve the generalization capability of a model being trained. In particular, the model trainer 845 may train the machine-learned models 885 based on a set of training data 850.

The training data 850 may include unlabeled training data for training in an unsupervised fashion. In an example, the training data 850 may include unlabeled sets of data indicative of cloud formations, snow/ice covered land, sea foam, etc. The training data 850 may be specific to satellite or constellation of satellites to help focus the machine-learned models 885 on a particular orbital pattern.

In an embodiment, training examples may be provided by the satellite 855 (e.g., satellite system 100). Thus, in such implementations, a model 885 provided to the satellite 855 may be trained by the computing system 805 in a manner to personalize the model 885.

The model trainer 845 may include computer logic utilized to provide desired functionality. The model trainer 845 may be implemented in hardware, firmware, and/or software controlling a general-purpose processor. For example, in an embodiment, the model trainer 845 may include program files stored on a storage device, loaded into a memory and executed by one or more processors. In other implementations, the model trainer 845 may include one or more sets of computer-executable instructions that are stored in a tangible computer-readable storage medium such as RAM, hard disk, or optical or magnetic media.

Computing system 805 may exchange data with satellite 855 using signals 810. Although one satellite 855 is illustrated in FIG. 8, any number of satellites may be configured to communicate with the computing system 805. In some implementations, satellite 855 may be associated with any suitable type of satellite system, including satellites, mini-satellites, micro-satellites, nano-satellites, etc. Satellite 855 may correspond to any of the satellites described herein (e.g., satellite system 100.).

Satellite 855 may include computing device(s) 860, which may include one or more processor(s) 865 and one or more memory device(s) 870. Processor(s) 865 may include one or more central processing units (CPUs), graphical processing units (GPUs), and/or other types of processors. Memory device(s) 870 may include one or more computer-readable media and may store information accessible by processor(s) 865, including instructions 875 that may be executed by processor(s) 865. For instance, memory device(s) 870 may store instructions 875 for implementing a command receive and image collect for capture image data; storing image data, commands, tracks, etc.; transmitting the image data to a remote computing device (e.g., computing system 805). In some implementations, execution of instructions 875 may cause processor(s) 865 to perform any of the operations and/or functions for which satellite 100 is configured. In some implementations, execution of instructions 875 may cause processor(s) 865 to perform, at least a portion of, method 700.

Memory device(s) 870 may also store data 880 that may be retrieved, manipulated, created, or stored by processor(s) 865. Data 880 may include, for instance, image acquisition commands, tracks, sequences, position data, data associated with the satellite, image data, and/or any other data and/or information described herein. Data 880 may be stored in one or more database(s). The one or more database(s) may be connected to computing device(s) 860 by a high bandwidth LAN or WAN, or may also be connected to computing device(s) 860 through various other suitable networks. The one or more database(s) may be split up so that they are located in multiple locales.

In an embodiment, the satellite 855 may store or include one or more machine-learned models 885. For example, the machine-learned models 885 may be or may otherwise include various machine-learned models. In an embodiment, the machine-learned models 885 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

In an embodiment, the one or more machine-learned models 885 may be received from the computing system 805 via one or more signals 810, stored in the satellite 855 (e.g., memory 870), and then used or otherwise implemented by the processors 865. In an embodiment, the satellite 855 may implement multiple parallel instances of a single model.

Additionally, or alternatively, one or more machine-learned models 885 may be included in or otherwise stored and implemented by the computing system 805 that communicates with the satellite 855 according to a client-server relationship. For example, the machine-learned models 885 may be implemented by the computing system 805 as a portion of GEO communication infrastructure. Thus, one or more models 885 may be stored and implemented at the satellite 855 and/or one or more models 885 may be stored and implemented at the computing system 805.

Satellite 855 may also include a communication interface 890 used to communicate with one or more remote computing device(s) (e.g., computing system 805, geostationary satellite(s), etc.) using signals 810. Communication interface 890 may include any suitable components for interfacing with one or more remote computing device(s), including for example, transmitters, receivers, ports, controllers, antennas, or other suitable components.

In some implementations, one or more aspect(s) of communication among the components of system 800 may involve communication through a network. In such implementations, the network may be any type of communications network, such as a local area network (e.g. intranet), wide area network (e.g. Internet), cellular network, or some combination thereof. The network may also include a direct connection, for instance, between one or more of the components. In general, communication through the network may be carried via a network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

Furthermore, computing tasks discussed herein as being performed at a server may instead be performed at a user device. Likewise, computing tasks discussed herein as being performed at the user device may instead be performed at the server.

While the present subject matter has been described in detail with respect to specific example embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

### Example Embodiments

In a 1st Example, a computing system of a satellite comprising: one or more sensors comprising a forward-looking sensor and an imaging sensor; one or more processors; and one or more tangible, non-transitory, computer-readable media storing instructions executable by the one or more processors to cause the computing system to perform operations, the operations comprising: receiving a command to capture image data of an imaging target; obtaining forward-looking sensor data from the forward-looking sensor of the satellite; determining, based on the forward-looking sensor data, a cloud coverage associated with the imaging target; comparing the cloud coverage associated with the imaging target to a threshold level of cloud coverage; and transmitting, based on comparing the cloud coverage associated with the imaging target to a threshold level of cloud coverage, an indication of a success metric or an indication of a failure metric associated with the forward-looking sensor data.

In a 2nd Example, the computing system of Example 1, wherein comparing the cloud coverage associated with the imaging target to the threshold level of cloud coverage comprises determining that the cloud coverage exceeds the threshold level of cloud coverage.

In a 3rd Example, the computing system of Example 2, wherein transmitting the indication of the success metric or the indication of the failure metric associated with the image data comprises transmitting an indication that the cloud coverage exceeds the threshold level of cloud coverage.

In a 4th Example, the computing system of any of Examples 1-3, wherein comparing the cloud coverage associated with the imaging target to the threshold level of cloud coverage comprises determining that the cloud coverage is within the threshold level of cloud coverage.

In a 5th Example, the computing system of Example 4, wherein transmitting the indication of the success metric or the indication of the failure metric associated with the image data comprises transmitting at least one of: (i) an indication that the cloud coverage is within the threshold level of cloud coverage, or (ii) the forward-looking sensor data of the imaging target.

In a 6th Example, the computing system of any of Examples 1-5, wherein the operations further comprise: capturing the image data of the image target with the imaging sensor in response to the success metric; and transmitting the image data to a ground station.

In a 7th Example, the computing system of any of Examples 1-6, wherein the operations further comprise: determining an updated imaging target based on the failure metric.

In a 8th Example, the computing system of Example 7, wherein the operations further comprise: determining, based on the updated imaging target, an updated trajectory for the satellite.

In a 9th Example, the computing system of any of Examples 1-8, wherein the operations further comprises transmitting the indication of the failure metric associated with the image data comprises transmitting the indication of the failure metric to a ground station via a downlink communication pathway comprising one or more relay satellites.

In a 10th Example, the computing system of any of Examples 1-9, wherein determining the cloud coverage associated with the imaging target is further based on a convolutional neural network (CNN) model.

In a 11th Example, the computing system of any of Examples 1-10, wherein the forward-looking sensor comprises at least one of: a VIS camera or a LWIR camera.

In a 12th Example, a computer-implemented method comprising: receiving a command to capture image data of an imaging target using a satellite; obtaining forward-looking sensor data from a forward-looking sensor of the satellite; determining, based on the forward-looking sensor data, a cloud coverage associated with the imaging target; comparing the cloud coverage associated with the imaging target to a threshold level of cloud coverage; and transmitting, based on comparing the cloud coverage associated with the imaging target to a threshold level of cloud coverage, an indication of a success metric or an indication of a failure metric associated with the forward-looking sensor data.

In a 13th Example, a non-transitory computer-readable media storing instructions that are executable by one or more processors to cause the one or more processors to perform operations, the operations comprising: receiving a command to capture image data of an imaging target using a satellite; obtaining forward-looking sensor data from a forward-looking sensor of the satellite; determining, based on the forward-looking sensor data, a cloud coverage associated with the imaging target; comparing the cloud coverage associated with the imaging target to a threshold level of cloud coverage; and transmitting, based on comparing the cloud coverage associated with the imaging target to a threshold level of cloud coverage, an indication of a success metric or an indication of a failure metric associated with the image data.

In a 14th Example, a computer-implemented method comprising: obtaining forward-looking sensor data of an image target using a forward-looking sensor of a satellite; analyzing, using a model, an image frame of the forward-looking sensor data; generating, using the model, a plurality of image segments, wherein the plurality of image segments is associated with one or more clouds depicted in the image frame; generating, using the model, a plurality of blurred image segments, wherein the plurality of blurred image segments are indicative of cloud characteristics; determining, using the model, a cloud coverage associated with respective blurred image segments of the plurality of blurred image segments; and transmitting, based on the cloud coverage associated with respective blurred image segments, an indication of a success metric or an indication of a failure metric associated with the forward-looking sensor data.

In a 15th Example, the computer-implemented method of Example 14, further comprising: comparing the cloud coverage associated with the imaging target to a threshold level of cloud coverage; and determining the success metric based on comparing the cloud coverage associated with the imaging target to the threshold level of cloud coverage.

In a 16th Example, the computer-implemented method of Example 15, further comprising: determining an updated trajectory for the satellite based on a current trajectory and on comparing the cloud coverage associated with the imaging target to the threshold level of cloud coverage.

In a 17th Example, a computer-implemented method comprising: obtaining, using a forward-looking sensor of a satellite, forward-looking sensor data associated with a forward-looking field of view, wherein the forward-looking field of view comprises an area of the Earth’s surface corresponding with a future field of view of an imagery sensor of the satellite; determining, based on the forward-looking sensor data, an estimated cloud coverage associated with one or more regions of the area of the Earth’s surface; selecting an image target from a region of the one or more regions within the future field of view, based on the estimated cloud coverage of the region being below a threshold level of cloud coverage; and capturing, using the imagery sensor, image data of the image target.

In a 18th Example, the computer-implemented method of Example 17, wherein selecting the image target is further based on a duration of time elapsed since a prior image of the region was captured.

In a 19th Example, the computer-implemented method of any of Examples 17-18, wherein selecting the image target is further based on a historical interest metric associated with the region.

In a 20th Example, the computer-implemented method of any of Examples 17-19, wherein selecting the image target is further based on a historical frequency of cloud-coverage-related imaging failures associated with the region.

In a 21st Example, the computer-implemented method of any of Examples 17-20, further comprising: generating, in response to selecting the image target, a command to modify an orientation of the satellite to align a field of view of the imagery sensor with the image target.

In a 22nd Example, the computer-implemented method of any of Examples 17-21, wherein the command to modify the orientation of the satellite comprises a slew command.

In a 23rd Example, the computer-implemented method of any of Examples 17-22, wherein the area of the Earth’s surface comprises a plurality of regions, and wherein selecting the image target comprises: ranking the plurality of regions based on a combination of the estimated cloud coverage and at least one secondary priority metric.

In a 24th Example, a computer-implemented method comprising: obtaining forward-looking sensor data having a forward-looking field of view using a forward-looking sensor of a satellite, wherein the forward-looking field of view comprises an area of Earth’s surface in a trajectory direction of the satellite which corresponds with a future field of view of an imagery sensor of the satellite; determining, based on the forward-looking sensor data, an estimated cloud coverage associated with one or more regions of the area of the Earth’s surface; transmitting the estimated cloud coverage associated with the one or more regions to a ground-based station; receiving, from a remote computing device, an image target for collection of image data; and transmitting to a remote computing device the estimated cloud coverage associated with a region of the one or more regions, in response to receiving the image target for the collection of image data by an image sensor of the satellite.

In a 25th Example, a computer-implemented method for tasking a collection of imagery data from a satellite, comprising: determining an estimated cloud coverage using one or more processors of the satellite; receiving from the satellite the estimated cloud coverage associated with one or more regions on Earth’s surface within a field of view of a forward-looking sensor; receiving, from a remote computing device, an image target associated with a location on the Earth’s surface; determining a current location of the satellite and an availability of the satellite; and generating a command configured to cause the satellite to collect the imagery data, based on the current location of the satellite and the availability of the satellite.

In a 26th Example, the computer-implemented method of Example 25, further comprising: transmitting, to the remote computing device, an indication of the estimated cloud coverage associated with a region of the one or more regions corresponding with the image target.

In a 27th Example, the computer-implemented method of any of Examples 25-26, wherein receiving the image target comprises receiving location data associated with the location.

In a 28th Example, the computer-implemented method of Example 27, wherein selecting the satellite is further based on the location data.

What is claimed is:

1. A computing system of a satellite comprising:
one or more sensors comprising a forward-looking sensor and an imaging sensor;
one or more processors; and
one or more tangible, non-transitory, computer-readable media storing instructions executable by the one or more processors to cause the computing system to perform operations, the operations comprising:
receiving a command to capture image data of an imaging target;
obtaining forward-looking sensor data from the forward-looking sensor of the satellite;
determining, based on the forward-looking sensor data, a cloud coverage associated with the imaging target;
comparing the cloud coverage associated with the imaging target to a threshold level of cloud coverage; and
transmitting, based on comparing the cloud coverage associated with the imaging target to a threshold level of cloud coverage, an indication of a success metric or an indication of a failure metric associated with the forward-looking sensor data.

2. The computing system of claim 1, wherein comparing the cloud coverage associated with the imaging target to the threshold level of cloud coverage comprises determining that the cloud coverage exceeds the threshold level of cloud coverage.

3. The computing system of claim 2, wherein transmitting the indication of the success metric or the indication of the failure metric associated with the image data comprises transmitting an indication that the cloud coverage exceeds the threshold level of cloud coverage.

4. The computing system of claim 1, wherein comparing the cloud coverage associated with the imaging target to the threshold level of cloud coverage comprises determining that the cloud coverage is within the threshold level of cloud coverage.

5. The computing system of claim 4, wherein transmitting the indication of the success metric or the indication of the failure metric associated with the image data comprises transmitting at least one of: (i) an indication that the cloud coverage is within the threshold level of cloud coverage, or (ii) the forward-looking sensor data of the imaging target.

6. The computing system of claim 1, wherein the operations further comprise:
capturing the image data of the image target with the imaging sensor in response to the success metric; and transmitting the image data to a ground station.

7. The computing system of claim 1, wherein the operations further comprise:
determining an updated imaging target based on the failure metric.

8. The computing system of claim 7, wherein the operations further comprise:
determining, based on the updated imaging target, an updated trajectory for the satellite.

9. The computing system of claim 1, wherein the operations further comprises transmitting the indication of the failure metric associated with the image data comprises transmitting the indication of the failure metric to a ground station via a downlink communication pathway comprising one or more relay satellites.

10. The computing system of claim 1, wherein determining the cloud coverage associated with the imaging target is further based on a convolutional neural network (CNN) model.

11. The computing system of claim 1, wherein the forward-looking sensor comprises at least one of: a VIS camera or a LWIR camera.

12. A computer-implemented method comprising:
receiving a command to capture image data of an imaging target using a satellite;
obtaining forward-looking sensor data from a forward-looking sensor of the satellite;
determining, based on the forward-looking sensor data, a cloud coverage associated with the imaging target;
comparing the cloud coverage associated with the imaging target to a threshold level of cloud coverage; and
transmitting, based on comparing the cloud coverage associated with the imaging target to a threshold level of cloud coverage, an indication of a success metric or an indication of a failure metric associated with the forward-looking sensor data.

13. The method of claim 12, wherein comparing the cloud coverage associated with the imaging target to the threshold level of cloud coverage comprises determining that the cloud coverage exceeds the threshold level of cloud coverage.

14. The method of claim 13, wherein transmitting the indication of the success metric or the indication of the failure metric associated with the image data comprises transmitting an indication that the cloud coverage exceeds the threshold level of cloud coverage.

15. The method of claim 12, wherein comparing the cloud coverage associated with the imaging target to the threshold level of cloud coverage comprises determining that the cloud coverage is within the threshold level of cloud coverage.

16. The method of claim 15, wherein transmitting the indication of the success metric or the indication of the failure metric associated with the image data comprises transmitting at least one of: (i) an indication that the cloud coverage is within the threshold level of cloud coverage, or (ii) the forward-looking sensor data of the imaging target.

17. The method of claim 12, further comprising:
capturing the image data of the image target with an imaging sensor in response to the success metric; and transmitting the image data to a ground station.

18. The method of claim 12, further comprising:
determining an updated imaging target based on the failure metric.

19. The method of claim 18, further comprising:
determining, based on the updated imaging target, an updated trajectory for the satellite.

20. A non-transitory computer-readable media storing instructions that are executable by one or more processors to cause the one or more processors to perform operations, the operations comprising:
receiving a command to capture image data of an imaging target using a satellite;
obtaining forward-looking sensor data from a forward-looking sensor of the satellite;
determining, based on the forward-looking sensor data, a cloud coverage associated with the imaging target;
comparing the cloud coverage associated with the imaging target to a threshold level of cloud coverage; and
transmitting, based on comparing the cloud coverage associated with the imaging target to a threshold level of cloud coverage, an indication of a success metric or an indication of a failure metric associated with the image data.
